(19) United States
(12) Patent Application Publication
(10) Pub. No.: US 2025/0304829 A1
(43) Pub. Date: Oct. 2, 2025

(54) METHOD FOR PRODUCING POLISHING COMPOSITION AND METHOD FOR PRODUCING RINSE COMPOSITION

(71) Applicant: FUJIMI INCORPORATED, Kiyosu-shi (JP)

(72) Inventors: Ryota MAE, Kiyosu-shi (JP); Yukinobu YOSHIZAKI, Kiyosu-shi (JP)

(73) Assignee: FUJIMI INCORPORATED, Kiyosu-shi (JP)

(21) Appl. No.: 19/092,470

(22) Filed: Mar. 27, 2025

(30) Foreign Application Priority Data
Mar. 29, 2024 (JP) 2024-056591

(51) Int. Cl. C09G 1/02

(52) U.S. Cl. CPC C09G 1/02

(57) ABSTRACT

The purpose of the present invention is to provide a novel method for producing a polishing composition and a novel method for producing a rinse composition, which enables reducing coarse particles and enables suppressing generation of defects. The method for producing a polishing composition includes preparing a first liquid by providing an abrasive grain dispersion containing abrasive grains and water, and filtering the abrasive grain dispersion; preparing a second liquid by providing at least one chemical component-containing aqueous solution containing a chemical component and water, and filtering the aqueous solution when one chemical component-containing aqueous solution is provided, or filtering a mixture X containing at least one chemical component-containing aqueous solution; and mixing the first liquid and the second liquid to prepare a third liquid, and filtering the third liquid.

### CROSS-REFERENCE TO RELATED APPLICATION

[symbol]

### BACKGROUND

### 1. Technical Field

The present invention relates to a method for producing a polishing composition and a method for producing a rinse composition.

### 2. Description of Related Arts

In the production of a semiconductor element, chemical mechanical polishing (CMP) treatment may be performed in which a surface of a substrate including a metal wiring film, a barrier metal, an insulating film, and the like is flattened by use of a polishing slurry containing polishing fine particles (of, for example, silica or alumina).

In recent years, semiconductor devices have been decreased in size with the advanced densification of integrated circuits and the like, and the required level of the surface quality of semiconductor substrates and magnetic disks has further risen. Various polishing compositions for CMP for improving surface quality have been proposed. For example, JP 2006-075975 A discloses a polishing liquid composition prepared by way of precise filtration through a filter such as a depth filter and a pleated filter for efficiently and economically removing aggregates of polishing primary particles or coarse polishing primary particles contained in the polishing liquid composition. It is claimed that such a polishing liquid composition ensures decreased surface roughness of a polished article after polishing, and markedly reduced nanoscratches (for example, JP 2006-075975 A). The document includes an example in which a polishing liquid composition is prepared by filtering a colloidal silica slurry as a polishing material, and then adding an acid component or the like for adjusting pH.

On the other hand, in the CMP treatment, metal components derived from polishing fine particles used in the CMP treatment, a polished wiring metal film, and/or a barrier metal are likely to remain on a surface of a semiconductor substrate after polishing. These residues can cause a short-circuit between wirings, and have impacts on electrical characteristics of the semiconductor. Therefore, a cleaning step of removing the residues from the surface of the semiconductor substrate has been carried out.

For example, JP 7340614 B2 discloses a method for cleaning a semiconductor substrate, including a cleaning step of cleaning a chemically and mechanically polished semiconductor substrate by use of a specific cleaning liquid. The document indicates that the cleaning liquid may contain coarse particles, but the content thereof is preferably low, and that an example of the method for removing coarse particles is refining treatment such as filtering.

### SUMMARY

However, the present inventors have found that conventional methods are not sufficient either as methods for producing a polishing composition having reduced coarse particles or as methods for producing a rinse composition having reduced coarse particles. If there are many defects in a semiconductor substrate, the characteristics of the semiconductor can be affected.

Accordingly, an object of the present invention is to provide a novel method for producing a polishing composition and a novel method for producing a rinse composition, which enables reducing coarse particles and enables suppressing generation of defects.

An aspect of the present invention is a method for producing a polishing composition, including preparing a first liquid by providing an abrasive grain dispersion containing abrasive grains and water, and filtering the abrasive grain dispersion; preparing a second liquid by providing at least one chemical component-containing aqueous solution containing a chemical component and water, and filtering the aqueous solution when one chemical component-containing aqueous solution is provided, or filtering a mixture X containing at least one chemical component-containing aqueous solution; and mixing the first liquid and the second liquid to prepare a third liquid, and filtering the third liquid.

An aspect of the present invention is a method for producing a rinse composition, including preparing a liquid A by providing at least one water-soluble polymer-containing liquid containing a water-soluble polymer and water, and filtering the liquid when one water-soluble polymer-containing liquid is provided and filtering a mixture Y when two or more water-soluble polymer-containing liquids are provided; preparing a liquid B by providing at least one chemical component-containing aqueous solution containing a chemical component and water, and filtering the aqueous solution when one chemical component-containing aqueous solution is provided, or filtering a mixture Z containing at least one chemical component-containing aqueous solution; and mixing the liquid A and the liquid B to prepare a liquid C, and filtering the liquid C.

According to the present invention, there can be provided a novel method for producing a polishing composition and a novel method for producing a rinse composition, which enables reducing coarse particles and enables suppressing generation of defects.

### DETAILED DESCRIPTION

As used herein, the expression “X to Y” is used to mean that it includes the head and last values (X and Y) as a lower limit value and an upper limit value, which means “X or more and Y or less”. In the case where a plurality of expressions “X to Y” appear, for example, “X1 to Y1 or X2 to Y2” is written, disclosures using each of the values as an upper limit, disclosures using each of the values as a lower limit, and combinations of those upper limits and lower limits are all disclosed (that is, there is a legitimate basis for amendments). Specifically, the amendment to X1 or more, the amendment to Y2 or less, the amendment to X1 or less, the amendment to Y2 or more, the amendment to X1 to X2, the amendment to X1 to Y2, and the like should all be construed as being legitimate. In addition, unless otherwise specified, operations and measurements of physical properties and the like are performed under the conditions of room temperature (20 to 25° C.) and a relative humidity of 40 to 50% RH. The concentration described herein may be a concentration at POU (point of use) or a concentration before dilution to the concentration at POU. The dilution ratio may be 2 to 10 or 2 to 5. In addition, in the case where features or aspects of the present disclosure are described in terms of Markush groups, those skilled in the art will appreciate that the present disclosure is accordingly described in terms of arbitrary individual constitutional elements or subgroups of constitutional elements of the Markush group. In addition, it should be understood that the present application discloses all combinations of embodiments or descriptions disclosed herein. That is, it should be understood that there can be a basis for amendments. In addition, the content or concentration of each component is described such that when two or more kinds of the component are contained, a total value of their contents or concentrations can be presented.

### Method for Producing Polishing Composition

An aspect of the present invention is a method for producing a polishing composition, including preparing a first liquid by providing an abrasive grain dispersion containing abrasive grains and water, and filtering the abrasive grain dispersion; preparing a second liquid by providing at least one chemical component-containing aqueous solution containing a chemical component and water, and filtering the aqueous solution when one chemical component-containing aqueous solution is provided, or filtering a mixture X containing at least one chemical component-containing aqueous solution; and mixing the first liquid and the second liquid to prepare a third liquid, and filtering the third liquid. Such an aspect can provide a novel method for producing a polishing composition, which enables reducing coarse particles and enables suppressing generation of defects.

### Step of Preparing First Liquid

A first liquid is prepared by providing an abrasive grain dispersion containing abrasive grains and water, and filtering the abrasive grain dispersion.

### Abrasive Grain Dispersion

The abrasive grain dispersion contains abrasive grains and water. The abrasive grain has an action of mechanically polishing an object to be polished. The abrasive grain is insoluble in water.

The abrasive grain may be any of an inorganic particle, an organic particle, and an organic-inorganic composite particle. Specific examples of the inorganic particle include particles of metal oxides such as silica, alumina, ceria and titania, silicon nitride particles, silicon carbide particles, and boron nitride particles. Specific examples of the organic particle include polymethyl methacrylate (PMMA) particles. One type of abrasive grains may be used, or two or more types of abrasive grains may be used in combination. For the abrasive grain, a commercially available product or a synthetic product may be used. The abrasive grain is preferably that of silica, particularly preferably colloidal silica. Therefore, according to an embodiment of the present invention, the abrasive grain contains silica. In addition, according to an embodiment of the present invention, the abrasive grain contains colloidal silica.

According to an embodiment of the present invention, 85 mass % or more, 90 mass % or more, 95 mass % or more, 98 mass % or more, or 99 mass % or more of the particles forming the abrasive grains are composed of silica (particularly colloidal silica) (the upper limit is 100 mass %).

The shape of the abrasive grain is not particularly limited, and may be spherical or non-spherical. Specific examples of the non-spherical shape include various shapes such as the shapes of polygonal prisms such as triangular prism and a quadrangular prism, a cylindrical shape, a straw bag shape in which a central portion of a cylinder has a larger size over an end portion thereof, a donut shape which is disk-shaped with a hole in the center, a plate shape, a so-called cocoon shape having a constriction at a central portion, a so-called associated spherical shape in which a plurality of particles are integrated, the shape of so-called kompeito which has a plurality of protrusions on a surface thereof, and a rugby ball shape, and are not particularly limited.

When colloidal silica is used as the abrasive grain, the surface of the colloidal silica may be surface-modified with a silane coupling agent or the like.

Examples of the method for surface-modifying the surface of colloidal silica with a silane coupling agent include the following immobilization method. For example, the surface modification can be performed by a method described in “Sulfonic acid-functionalized silica through quantitative oxidation of thiol groups”, Chem. Commun. 246-247 (2003). Specifically, a silane coupling agent having a thiol group, such as 3-mercaptopropyltrimethoxysilane, is coupled to colloidal silica, and the thiol group is then oxidized with hydrogen peroxide, whereby colloidal silica having sulfonic acid immobilized on the surface thereof can be obtained. Alternatively, the surface modification can be performed by, for example, a method described in “Novel Silane Coupling Agents Containing a Photolabile 2-Nitrobenzyl Ester for Introduction of a Carboxy Group on the Surface of Silica Gel”, Chemistry Letters, 3,228-229 (2000). Specifically, a silane coupling agent containing a 2-nitrobenzyl ester having photoreactivity is coupled to colloidal silica, followed by light irradiation, whereby colloidal silica having a carboxylic acid immobilized on the surface thereof can be obtained.

While colloidal silica having an anionic group (anionically modified colloidal silica) is described above, colloidal silica having a cationic group (cationically modified colloidal silica) may be used. Examples of the colloidal silica having a cationic group include colloidal silica having an amino group is immobilized on the surface thereof. Examples of the method for producing the colloidal silica having a cationic group include a method in which a silane coupling agent having an amino group, such as aminoethyltrimethoxysilane, aminopropyltrimethoxysilane, aminoethyltriethoxysilane, aminopropyltriethoxysilane, aminopropyldimethylethoxysilane, aminopropylmethyldiethoxysilane or aminobutyltriethoxysilane, is immobilized on the surface of the colloidal silica as described in JP 2005-162533 A. In this way, colloidal silica having an amino group immobilized on the surface thereof can be obtained.

The size of the abrasive grains is not particularly limited. For example, the average primary particle size of the abrasive grains is 5 nm or more, 10 nm or more, or 15 nm or more. In addition, the average primary particle size of the abrasive grains is 120 nm or less, 80 nm or less, 50 nm or less, 40 nm or less, 30 nm or less, or 19 nm or less. The average primary particle size of the abrasive grains can be calculated from, for example, a specific surface area (SA) of the abrasive grains which is calculated by a BET method, where the shape of the abrasive grain is assumed to be perfectly spherical. Herein, as the average primary particle size of the abrasive grains, a value measured by the method described in Examples is adopted.

In addition, the average secondary particle size of the abrasive grains can be, for example, 16 nm or more, 20 nm or more, or 24 nm or more. The average secondary particle size of the abrasive grains is 250 nm or less, 200 nm or less, 150 nm or less, 100 nm or less, 50 nm or less, or 30 nm or less. The average secondary particle size of the abrasive grains can be measured by, for example, a dynamic light scattering method typified by a laser diffraction scattering method. Herein, as the average secondary particle size of the abrasive grains, a value measured by the method described in Examples is adopted.

The average degree of association of the abrasive grains can be 5.0 or less, 4.0 or less, or 3.0 or less. As the average degree of association of the abrasive grains decreases, defects can be reduced. The average degree of association of the abrasive grains can be 1.0 or more, 1.5 or more, or 2.0 or more. The average degree of association is obtained by dividing the value of the average secondary particle size of the abrasive grains by the value of the average primary particle size. As the average degree of association of the abrasive grains increases, the polishing removal rate in an object to be polished with the polishing composition is improved, which is an advantageous effect.

The upper limit of the aspect ratio of the abrasive grains is not particularly limited, and can be less than 2.0, 1.8 or less, or 1.5 or less. When the above-mentioned upper limit is in such a range, defects on the surface of the object to be polished can be further reduced. The aspect ratio is an average of values obtained by identifying, under a scanning microscope, the smallest rectangle circumscribed around an image of an abrasive grain particle, and dividing the length of the long side of the rectangle by the length of the short side of the rectangle, and can be determined by use of common image analysis software. The lower limit of the aspect ratio of the abrasive grains in the polishing composition is not particularly limited, but is preferably 1.0 or more.

In a particle size distribution of the abrasive grains which is determined by a laser diffraction scattering method, the lower limit of D90/D10, which is a ratio between a particle diameter at which the cumulative particle mass reaches 90% of the mass of all particles (D90) and a particle diameter at which the cumulative particle mass reaches 10% of the mass of all particles (D10) with respect to the smallest particle size, is not particularly limited, and can be 1.1 or more, 1.2 or more, 1.3 or more, 2.0 or more, or 2.5 or more. In a particle size distribution of the abrasive grains which is determined by a laser diffraction scattering method, the upper limit of the ratio between a particle diameter at which the cumulative particle mass reaches 90% of the mass of all particles (D90) and a particle diameter at which the cumulative particle mass reaches 10% of the mass of all particles (D10), D90/D10, with respect to the smallest particle size, is not particularly limited, and can be 5.0 or less, 4.5 or less, 4.0 or less, or 3.0 or less. When the above-mentioned upper limit is in such a range, defects on the surface of the object to be polished can be further reduced.

The sizes (average primary particle size, average secondary particle size, aspect ratio, D90/D10 and the like) of the abrasive grains can be appropriately controlled by, for example, selecting a method for producing abrasive grains.

The content (concentration) of the abrasive grains is not particularly limited. According to an embodiment of the present invention, it is 5 mass % or more, 10 mass % or more or 15 mass % or more per total mass of the abrasive grain dispersion. The content (concentration) of the abrasive grains is not particularly limited, and is 40 mass % or less, 30 mass % or less or 25 mass % or less per total mass of the abrasive grain dispersion. When the polishing composition contains two or more kinds of abrasive grains, the content of the abrasive grains means the total amount of these abrasive grains.

### Filtering of Abrasive Grain Dispersion

The material of the filter for filtering the abrasive grain dispersion is not particularly limited, and examples thereof include resins such as polycarbonate, mixed cellulose esters, polyvinylidene fluoride (PVDF), polytetrafluoroethylene (PTFE), ethylene-tetrafluoroethylene copolymers, polycarbonate, polyethersulfone, cellulose acetate, nitrocellulose, regenerated cellulose, polyamide, triacetylcellulose, polypropylene, polyvinyl chloride (PVC), nylon, nylon 66, polysulfone, polyester, polypropylene/polyethylene, acrylic copolymers, polycarbonate, polylactic acid, polycaprolactone, polyglycolic acid, polydioxanone, polyhydroxy butyrate, polybutadiene, polyurethane, polystyrene (PS), polymethyl methacrylate, and polycarbonate, glass, and metals. Among them, polypropylene is preferable from the viewpoint of cost and high resistance to chemicals.

The pore size of the filter is not particularly limited, but is preferably 0.03 μm or more, 0.04 μm or more, 0.05 μm or more, 0.1 μm or more, 0.2 μm or more, 0.5 μm or more, 1.0 μm or more, 1.5 μm or more, 2.1 μm or more, 2.5 μm or more, or 2.8 μm or more. The pore size is particularly preferably 2.1 μm or more, 2.5 μm or more, or 2.8 μm or more because a high filtration rate is obtained. In addition, the pore size of the filter can be 10.0 μm or less, 8.0 μm or less, 5.0 μm or less, 4.0 μm or less, or 3.0 μm or less. When the upper limit is as mentioned above, it is possible to efficiently remove aggregates generated in the abrasive grain dispersion.

The form of the filter is not particularly limited. Filters having different structures, shapes, and functions can be appropriately utilized. As a specific example, a filter of pleated type, depth type, depth-pleated type, membrane type, or adsorption type is preferably utilized. The structure of the filter is not particularly limited, and may be in the form of a bag having a bag shape, or a cartridge having a hollow cylinder shape. The cartridge filter may be of gasket type or ring type.

The diameter of the filter (for example, the diameter of a filter of membrane type) can be appropriately determined according to a production scale.

The filtration method for performing filtering may be any of natural filtration performed at ordinary pressure, suction filtration, pressure filtration, and centrifugal filtration, but is preferably pressure filtration in view of productivity.

The filtration rate in filtering is preferably 100 to 300,000 ml/min (m), 100 to 10,000 ml/min (m), or 100 to 1,000 ml/min (m).

The filtering time is preferably 1 to 100 minutes, 3 to 50 minutes, or 5 to 30 minutes.

The filter used in the present step may be a commercially available product. Examples of the commercially available filter include 43L-SLS-030-EF (manufactured by Roki Techno Co., Ltd.).

The first liquid is prepared by filtering the abrasive grain dispersion as described above.

### Step of Preparing Second Liquid

A second liquid is prepared by providing at least one chemical component-containing aqueous solution containing a chemical component and water, and filtering the aqueous solution when one chemical component-containing aqueous solution is provided, or filtering a mixture X containing at least one chemical component-containing aqueous solution.

### Chemical Component-Containing Aqueous Solution

The chemical component-containing aqueous solution contains a chemical component and water. The chemical component has an action of chemically polishing an object to be polished. Herein, the chemical component is a concept that abrasive grains, a water-soluble polymer, and a non-aqueous additive which is liquid at 25° C. are excluded. As the chemical component, components which are commonly used in the art can be used without particular limitation.

At least one chemical component-containing aqueous solution are provided. When one chemical component-containing aqueous solution is provided, the one chemical component-containing aqueous solution is filtered to prepare the second liquid. When a mixture X containing at least one chemical component-containing aqueous solution is provided, the mixture X is filtered to prepare the second liquid.

The method for preparing the mixture X is not limited as long as it contains at least one chemical component-containing aqueous solution.

The mixture X is provided by, for example, mixing two or more chemical component-containing aqueous solutions with each other.

In addition, the mixture X may be prepared by first providing one chemical component-containing aqueous solution, and mixing the chemical component-containing aqueous solution with at least one selected from the group consisting of a chemical component (which is not in the form of an aqueous solution), a water-soluble polymer, and a non-aqueous additive which is liquid at 25° C.

In addition, the mixture X may be prepared by mixing a chemical component (which is not in the form of an aqueous solution) and at least one selected from the group consisting of a chemical component (which is not in the form of an aqueous solution), a non-aqueous additive which is liquid at 25° C., and a water-soluble polymer, with water. In this case, at least one chemical component-containing aqueous solution containing a chemical component and water are provided in parallel to preparation of the mixture X.

According to an embodiment of the present invention, the chemical component is an organic acid, an inorganic acid, an organic acid salt, an inorganic acid salt, a saccharide, a basic compound, or the like. Examples of the salt include alkali metal salts and ammonium salts of sodium, potassium and the like.

Examples of the organic acid include organic carboxylic acids such as citric acid, maleic acid, malic acid, glycolic acid, succinic acid, itaconic acid, malonic acid, iminodiacetic acid, gluconic acid, lactic acid, mandelic acid, tartaric acid, formic acid, acetic acid, propionic acid, butyric acid, adipic acid, oxalic acid, valeric acid, enanthic acid, caproic acid, caprylic acid, pelargonic acid, capric acid, lauric acid, myristic acid, palmitic acid, margaric acid, stearic acid, cyclohexanecarboxylic acid, phenylacetic acid, benzoic acid, crotonic acid, oleic acid, linoleic acid, linolenic acid, ricinolenic acid, methacrylic acid, glutaric acid, fumaric acid, phthalic acid, isophthalic acid, terephthalic acid, tartronic acid, glyceric acid, hydroxybutyric acid, hydroxyacetic acid, hydroxybenzoic acid, salicylic acid, isocitric acid, methylenesuccinic acid, gallic acid, ascorbic acid, nitroacetic acid, oxaloacetic acid, chloroacetic acid, dichloroacetic acid and trichloroacetic acid; amino acids such as glycine, alanine, glutamic acid, aspartic acid, valine, leucine, isoleucine, serine, threonine, cysteine, methionine, phenylalanine, tryptophan, tyrosine, proline, cystine, glutamine, asparagine, lysine and arginine; nicotinic acid; picric acid; picolinic acid; phytic acid; organic phosphonic acids such as 1-hydroxyethylidene-1,1-diphosphonic acid, aminotri (methylenephosphonic acid), ethylenediamine tetra (methylenephosphonic acid), diethylenetriamine penta (methylenephosphonic acid), ethane-1,1-diphosphonic acid, ethane-1,1,2-triphosphonic acid, ethane-1-hydroxy-1,1-diphosphonic acid, ethanehydroxy-1,1,2-triphosphonic acid, ethane-1,2-dicarboxy-1,2-diphosphonic acid, methanehydroxyphosphonic acid, 2-phosphonobutane-1,2-dicarboxylic acid, 1-phosphonobutane-2,3,4-tricarboxylic acid, α-tetraphenylphosphonium acid and aminopoly(methylenephosphonic acid); and organic sulfonic acids such as xylenesulfonic acid, methanesulfonic acid, ethanesulfonic acid, aminoethanesulfonic acid, benzenesulfonic acid, p-toluenesulfonic acid, 2-naphthalenesulfonic acid, sulfosuccinic acid, 10-camphorsulfonic acid, isethionic acid and taurine.

Examples of the inorganic acid include phosphoric acid (orthophosphoric acid), nitric acid, sulfuric acid, hydrochloric acid, boric acid, sulfamic acid, phosphinic acid, phosphonic acid, pyrophosphoric acid, tripolyphosphoric acid, tetrapolyphosphoric acid, hexametaphosphoric acid, carbonic acid, hydrofluoric acid, sulfurous acid, thiosulfuric acid, chloric acid, perchloric acid, chlorous acid, hydroiodic acid, periodic acid, iodic acid, hydrobromic acid, perbromic acid, bromic acid, chromic acid, and nitrous acid.

Examples of the saccharide include monosaccharides such as tetrose such as erythrose, threose and erythrulose; pentose such as ribose, arabinose, xylose, lyxose, xylulose and ribulose; and hexose such as allose, altrose, glucose, mannose, gulose, idose, galactose, talose, fructose, sorbose, psicose and tagatose; and oligosaccharides such as maltose, isomaltose, cellobiose, gentiobiose, melibiose, lactose, turanose, trehalose, saccharose, mannitriose, cellotriose, gentianose, raffinose, melezitose, cellotetrose and stachyose. In addition, other saccharides may be used, for example, heptose, deoxy sugars, amino sugars such as N-methyl-D-glucamine, thio sugars, seleno sugars, aldonic sugars, uronic acid, sugar acids, ketoaldonic acid, anhydrosugars, unsaturated sugars, sugar esters, sugar ethers, and residues such as glycosides, or polysaccharides such as starch, glycogen, cellulose, chitin and chitosan, or hydrolyzed products thereof.

Specific examples of the basic compound include hydroxides or salts of alkali metals, quaternary ammonium hydroxides or salts thereof, ammonia, and amines. Examples of the alkali metal include potassium and sodium. Examples of the salt include carbonates, hydrogencarbonates, sulfates, and acetates. Examples of the quaternary ammonium include tetramethylammonium, tetraethylammonium, and tetrabutylammonium. The quaternary ammonium hydroxide compound includes quaternary ammonium hydroxide or a salt thereof, and specific examples thereof include tetramethylammonium hydroxide, tetraethylammonium hydroxide, and tetrabutylammonium hydroxide. Specific examples of the amine include 2-amino-2-ethyl-1,3-propanediol, methylamine, dimethylamine, trimethylamine, ethylamine, diethylamine, triethylamine, ethylenediamine, monoethanolamine, N-(β-aminoethyl ethanolamine, hexamethylenediamine, diethylenetriamine, triethylenetetramine, anhydrous piperazine, piperazine hexahydrate, 1-(2-aminoethyl)piperazine, N-methylpiperazine, and guanidine. These basic compounds may be used alone, or in combination of two or more thereof.

According to an embodiment of the present invention, the chemical component is an alcohol (for example, methanol or ethanol). According to an embodiment of the invention, a chemical component which is liquid at 25° C. is not filtered before being mixed to form the mixture X. According to such an embodiment, both quality and productivity can be secured.

According to an embodiment of the present invention, the concentration of the chemical component in the chemical component-containing aqueous solution can be 0.1 to 20 mass %, 0.2 to 15 mass %, or 0.5 to 12 mass %. When two or more chemical components are provided, the concentrations of the chemical components in the chemical component-containing aqueous solution may be the same, or at least partially different.

According to an embodiment of the present invention, the chemical component used to prepare at least one chemical component-containing aqueous solution is solid at 25° C. The present inventors have found that, in particular, if a chemical component-containing aqueous solution containing a chemical component which is solid at 25° C. and water is used for preparation of a polishing composition, a desired effect of the present invention cannot be obtained even when the abrasive grain dispersion is filtered and/or filtering is performed immediately before an end product of the polishing composition is obtained (that is, even when the third liquid is filtered). The present inventors presume that this is because the chemical component which is solid at 25° C. is not completely dissolved and remains in the chemical component-containing aqueous solution. This is particularly marked in preparation of the mixture X. Thus, by filtering the chemical component-containing aqueous solution (in particular, the mixture X), a desired effect of the present invention can be more efficiently obtained.

According to an embodiment of the present invention, when two or more chemical component-containing aqueous solutions are provided, one or more thereof are filtered in advance before the mixture X is prepared. That is, according to an embodiment of the present invention, the mixture X is prepared by providing two or more chemical component-containing aqueous solutions, and filtering at least one of the aqueous solutions, followed by mixing them. According to such an embodiment, higher quality can be obtained.

According to an embodiment of the present invention, the chemical component used to prepare at least one chemical component-containing aqueous solution is in a liquid form at 25° C. According to an embodiment of the present invention, the mixture X is prepared by providing a chemical component which is in a liquid form at 25° C., and mixing the chemical component which is in a liquid form at 25° C. with the chemical component-containing aqueous solution without filtering the chemical component in advance. According to such an embodiment, there is the effect of enabling improvement of productivity while securing quality.

### Water-Soluble Polymer-Containing Liquid

The water-soluble polymer mainly has an action of protecting an object to be polished, and an action as a wetting agent. Therefore, the water-soluble polymer may be added to the polishing composition. That is, a method for producing a polishing composition according to an embodiment of the present invention includes providing at least one water-soluble polymer-containing liquid containing a water-soluble polymer and water, and using it for preparation of a polishing composition. According to an embodiment of the present invention, the mixture X is prepared by providing at least one water-soluble polymer-containing liquid containing a water-soluble polymer and water, and mixing the water-soluble polymer-containing liquid with the chemical component-containing aqueous solution.

Herein, the water-soluble polymer is solid (powder form) at 25° C., and can be dissolved in water to form a liquid. The water-soluble polymer-containing liquid can be prepared by dissolving the water-soluble polymer in water. Here, the term “water-soluble” means that the desolubility in water (25° C.) is 1 g/100 mL or more, and the term “polymer” refers to a (co) polymer containing a repeat unit in its molecular structure and having a weight average molecular weight (Mw) of 1,000 or more. Herein, as the “weight average molecular weight”, a value of weight average molecular weight measured by gel permeation chromatography (GPC) (in terms of polyethylene glycol) can be used. The weight average molecular weight can be measured using the following apparatuses and conditions.
GPC apparatus: manufactured by Shimadzu Corporation
Model: Prominence+ELSD Detector (ELSD-LTII)
Column: VP-ODS (manufactured by Shimadzu Corporation)
Mobile phase A: MeOH
B: 1% aqueous solution of acetic acid
Flow rate: 1 mL/min
Detector: ELSD temp. 40° C., Gain 8, N₂GAS 350 kPa
Oven temperature: 40° C.
Injection volume: 40 μL

As described above, filtering the aqueous solution when one chemical component-containing aqueous solution is provided, or filtering the mixture X containing the chemical component-containing aqueous solution is sufficient, but when a water-soluble polymer-containing liquid is also used for the preparation of the mixture X, and higher quality needs to be obtained, the mixture X is prepared by filtering the water-soluble polymer-containing liquid in advance. At least one water-soluble polymer-containing liquid may be provided.

As the water-soluble polymer, one having at least one functional group selected from a cationic group, an anionic group and a nonionic group in the molecule can be used. Specific examples of the water-soluble polymer include those containing a hydroxyl group, a carboxyl group, an acyloxy group, a sulfo group, a quaternary ammonium structure, a heterocyclic structure, a vinyl structure, a polyoxyalkylene structure, or the like in the molecule. Preferred examples thereof include polymers containing a nitrogen atom, polyvinyl alcohol (polyvinyl alcohol having a saponification degree of 70 mol % or more), and cellulose derivatives. The term “cellulose derivative” means a derivative of cellulose in which at least one of hydroxyl groups of water-insoluble cellulose is replaced by a substituent to impart water-solubility. Here, cellulose is obtained by linear polymerization of a large number of β-glucose molecules via glycoside bonds. The constituent unit of cellulose has hydroxyl groups at positions C2, C3 and C6. Since the hydroxyl group forms strong hydrogen bonding in a molecule and between molecules, cellulose is generally insoluble in water or an organic solvent. However, the cellulose derivative can be made soluble in water by replacing at least a part of hydroxyl groups of cellulose by a substituent and cleaving at least a part of the hydrogen bonding.

More specific examples include cellulose derivatives, imine derivatives such as poly(N-acylalkyleneimine), polyvinyl alcohol, polyvinyl pyrrolidone, copolymers containing polyvinyl pyrrolidone as a part of the structure, polyvinyl caprolactam, copolymers containing polyvinyl caprolactam as a part of the structure, polyoxyethylene, polymers containing an oxyalkylene unit, these polymers arranged in a diblock form, a triblock form, a random form, an alternate form or the like to form a polymer having a plurality of structures, and polyether-modified silicone.

Among them, cellulose derivatives, polyvinyl alcohol, polyvinyl pyrrolidone, or polymers containing an oxyalkylene unit are preferable from the viewpoint of well serving to impart hydrophilicity. Specific examples of the cellulose derivative include cellulose derivatives such as hydroxyethyl cellulose, hydroxypropyl cellulose, hydroxyethyl methyl cellulose, methyl cellulose, hydroxypropyl methyl cellulose, ethyl cellulose, ethyl hydroxyethyl cellulose and carboxymethyl cellulose, and pullulan. Among the cellulose derivatives, hydroxyethyl cellulose is preferable from the viewpoint of high ability to impart wettability to the polished surface, and good cleaning properties.

In an embodiment of the present invention, the weight average molecular weight of the water-soluble polymer can be 1,000 to 3,000,000, 2,000 to 2,000,000, or 3,000 to 1,500,000. When two or more water-soluble polymers are provided, the weight average molecular weights of the water-soluble polymers may be the same, or at least partially different.

According to an embodiment of the present invention, the concentration of the water-soluble polymer in the water-soluble polymer-containing liquid can be 0.1 to 10 mass %, 0.2 to 5 mass %, or 0.5 to 2 mass %. When two or more water-soluble polymers are provided, the concentrations of the water-soluble polymers may be the same, or at least partially different.

According to an embodiment of the present invention, the water-soluble polymer present in at least one of the water-soluble polymer-containing liquids has a radius of inertia of 10 nm or more, 50 nm or more, 80 nm or more, or 100 nm or more. According to an embodiment of the present invention, the water-soluble polymer present in at least one of the water-soluble polymer-containing liquids has a radius of inertia of 300 nm or less, 250 nm or less, 200 nm or less, or 180 nm or less. Herein, the radius of inertia can be calculated by the measurement method described in Examples. When two or more water-soluble polymers are provided, the radii of inertia of the water-soluble polymers in the water-soluble polymer-containing liquid may be the same, or at least partially different.

### Non-Aqueous Additive Which Is Liquid at 25° C.

A non-aqueous additive which is liquid at 25° C. may be added to the polishing composition for the purpose of imparting certain characteristics. The non-aqueous additive which is in a liquid form at 25° C. is a non-aqueous additive which has an oxyalkylene unit, and is in a liquid form at 25° C. even when it is not dissolved in water.

Examples of the compound containing an oxyalkylene unit include ethylene glycol, propylene glycol, polyethylene glycol (polyethylene oxide (PEO)), polypropylene glycol (propylene oxide (PO)), block copolymers of ethylene oxide (EO) and propylene oxide (PO), and random copolymers of EO and PO. The block copolymer of EO and PO can be a diblock form or a triblock form containing a polyethylene oxide (PEO) block and a polypropylene oxide (PPO) block. The triblock form includes a PEO-PPO-PEO triblock form and a PPO-PEO-PPO triblock form. Normally, a PEO-PPO-PEO triblock form is more preferable. In the block copolymer or the random copolymer of EO and PO, the molar ratio of EO and PO forming the copolymer (EO/PO) is preferably more than 1, more preferably 2 or more, and still more preferably 3 or more (for example, 5 or more), from the viewpoint of solubility in water and the like. Two or more non-aqueous additives which are liquid at 25° C. may be used in combination.

In an embodiment of the present invention, the weight average molecular weight of the non-aqueous additive which is liquid at 25° C. is preferably 50 to 5,000, more preferably 120 to 2,000, and still more preferably 150 to 1,000.

According to an embodiment of the present invention, the mixture X is prepared by providing a non-aqueous additive which is liquid at 25° C., and mixing the non-aqueous additive with the chemical component-containing aqueous solution without prior filtration of the non-aqueous additive. According to such an embodiment, there is the effect of enabling improvement of productivity while securing quality. That is, although one of the features of the present invention is filtering a chemical component-containing aqueous solution prepared by mixing a chemical component (in particular, a chemical component which is solid at 25° C.) and water (a mixture X containing the chemical component-containing aqueous solution), the filtering is not performed because for the non-aqueous additive which is liquid at 25° C. (for example, polyethylene glycol), there is no possibility that a component which is not completely dissolved will precipitate. Thus, for production of the polishing composition, it is possible to provide a production method capable of securing both quality and productivity by selecting an object to be filtered on the basis of a clear technical idea instead of performing filtering with respect to all components without reason.

The mass ratio of the components for preparing the mixture X can vary depending on the characteristics of an intended polishing composition, and for example, when the mixture X is provided by mixing an aqueous solution of an organic carboxylic acid such as maleic acid, an aqueous solution of an organic sulfonic acid such as xylene sulfonic acid, an aqueous solution of an amino sugar such as N-methyl-D-glucamine, and a non-aqueous additive such as polyethylene glycol, the mixing mass ratio thereof is preferably 2 to 25:2 to 25:35 to 55:15 to 35, 10 to 20:10 to 20:35 to 50:20 to 30, or the like. Note that the value is selected such that the sum is 100.

For example, when the mixture X is provided by mixing an aqueous solution of an organic carboxylic acid such as maleic acid, a compound containing an oxyalkylene unit, and a powdered organic carboxylic acid (for example, iminodiacetic acid) (which is not in the form of an aqueous solution), the mixing mass ratio thereof is preferably 60 to 90:5 to 20:1 to 10 or 70 to 88:7 to 15:1 to 5. Note that the value is selected such that the sum is 100.

The material of the filter for filtering at least one of chemical component-containing aqueous solution and the mixture X is not particularly limited, and examples thereof include resins such as polycarbonate, mixed cellulose esters, polyvinylidene fluoride (PVDF), polytetrafluoroethylene (PTFE), ethylene-tetrafluoroethylene copolymers, polycarbonate, polyethersulfone, cellulose acetate, nitrocellulose, 1 regenerated cellulose, polyamide, triacetylcellulose, polypropylene, polyvinyl chloride (PVC), nylon, nylon 66, polysulfone, polyester, polypropylene/polyethylene, acrylic copolymers, polycarbonate, polylactic acid, polycaprolactone, polyglycolic acid, polydioxanone, polyhydroxy butyrate, polybutadiene, polyurethane, polystyrene (PS), polymethyl methacrylate, and polycarbonate, glass, and metals. Among them, nylon and nylon 66 are preferable from the viewpoint of cost and high resistance to chemicals.

The pore size of the filter is not particularly limited, but is preferably 0.03 μm or more, 0.04 μm or more, 0.05 μm or more, or 0.1 μm or more. The pore size of the filter can be 10.0 μm or less, 8.0 μm or less, 5.0 μm or less, 4.0 μm or less, 3.0 μm or less, 2.5 μm or less, 2.1 μm or less, 1.5 μm or less, 1.2 μm or less, 0.9 μm or less, 0.7 μm or less, 0.5 μm or less, or 0.3 μm or less. In particular, when the thickness is 0.7 μm or less, 0.5 μm or less, or 0.3 μm or less, aggregates that can be generated in at least one of the chemical component-containing aqueous solution and the mixture X can be efficiently removed.

The form of the filter is not particularly limited. Filters having different structures, shapes, and functions can be appropriately utilized. As a specific example, a filter of pleated type, depth type, depth-pleated type, membrane type, or adsorption type is preferably utilized. The structure of the filter is not particularly limited, and may be in the form of a bag having a bag shape, or a cartridge having a hollow cylinder shape. The cartridge filter may be of gasket type or ring type.

The filtration method for performing filtering may be any of natural filtration performed at ordinary pressure, suction filtration, pressure filtration, and centrifugal filtration, but is preferably pressure filtration in view of productivity.

The filtration rate in filtering is preferably 100 to 300,000 ml/min (m), 100 to 10,000 ml/min (m), or 100 to 1,000 ml/min (m).

The filtering time is preferably 1 to 100 minutes, 3 to 50 minutes, or 5 to 30 minutes.

As the filter, a commercially available product can also be used in the present step. Examples of the commercially available filter for use in the present step include ULTIPLEAT (registered trademark) P-nylon 66 and ULTIPORE (registered trademark) N66 manufactured by Nihon Pall Ltd.

In this way, a second liquid is prepared.

### Step of Preparing Third Liquid and Filtering the Third Liquid

The third liquid can be prepared by mixing the first liquid and the second liquid. Here, water can be mixed in addition to the first liquid and the second liquid. In an embodiment of the present invention, the mixing mass ratio of the first liquid, the second liquid and water can vary depending on the characteristics of an intended polishing composition, and is, for example, 100 to 500:10 to 200:400 to 800, or 250 to 350:50 to 150:500 to 700, or may be 20 to 70:80 to 300:630 to 900, or 30 to 60:80 to 200:710 to 890. Note that the value is selected such that the sum is 1,000. The mixing mass ratio of the first liquid, the second liquid and water may be, for example, 20 to 80:50 to 300:620 to 930 or 30 to 60:80 to 300:700 to 890. Note that the value is selected such that the sum is 1,000.

The mixing method is not particularly limited, and for example, the mixture can be prepared by use of a well-known mixing device such as a propeller stirrer, an ultrasonic disperser, or a homomixer. The respective liquids for the polishing composition may be mixed at the same time, or may be mixed in an arbitrary sequence.

The polishing composition can be produced by filtering the third liquid in the present step.

In a preferred embodiment of the present invention, it is preferable that as the filtering of the third liquid, filtering similar to the filtering performed on the abrasive grain dispersion, which is described above, is applied, followed by application of filtering similar to the filtering performed on at least one of the chemical component-containing aqueous solution and the mixture X. According to such an embodiment, a desired effect of the present invention can be efficiently exhibited. Of course, the explanation of the filtering of the abrasive grain dispersion and the description of the filtering of the chemical component-containing aqueous solution and the mixture X can also be applied in the present step. For the filtering similar to the filtering performed on at least one of the chemical component-containing aqueous solution and the mixture X, which is applied in the present step, it is preferable to adopt a filtration rate lower than the filtration rate adopted in the filtering performed on at least one of the chemical component-containing aqueous solution and the mixture X. According to an embodiment of the present invention, the filtration rate (ml/min) adopted in the filtering performed on at least one of the chemical component-containing aqueous solution and the mixture X with respect to the filtration rate (ml/min) adopted in the filtering similar to the filtering performed on at least one of the chemical component-containing aqueous solution and the mixture X, which is applied in the present step, is preferably 0.1 to 10 or 0.5 to 5.

In the polishing composition thus produced, the number of coarse particles having a particle size of more than 0.15 μm can be 1,000,000 or less, 8,000,000 or less, 5,000,000 or less, 2,000,000 or less, 1,500,000 or less, 1,000,000 or less, or 500,000 or less per 1 ml of the polishing composition. The method for measuring the coarse particles follows the method described in Examples.

The polishing composition of the present invention may be of one-component type or multi-component type such as two-component type. In addition, the polishing composition of the present invention may be prepared by diluting a stock solution of the polishing composition, for example, 10-fold or more with a diluent such as water.

### Application of Polishing Composition

The polishing composition obtained as described above can be preferably used for polishing an object to be polished. The object to be polished is not particularly limited, and is, for example, a wafer of a metal or semiconductor such as a silicon, polysilicon, aluminum, nickel, tungsten, copper, tantalum, titanium or stainless steel, or an alloy thereof; glassy substances such as quartz glass, aluminosilicate glass, and glassy carbon; a ceramic materials such as alumina, silica, sapphire, silicon nitride, tantalum nitride, or titanium carbide; a compound semiconductor wafer material such as silicon carbide, gallium nitride, or gallium arsenide; or a resin material such as a polyimide resin. In addition, the size of the abrasive grains is not particularly limited. The polishing composition can be preferably applied to polishing of an object to be polished, which has a plate shape, a polyhedron shape or the like, and has a flat surface.

The object to be polished is polished by use of a polishing apparatus. As the polishing apparatus, a common polishing apparatus can be used which is equipped with a holder for holding an object to be polished, a motor capable of changing the number of rotations, and the like, and includes a polishing table to which a polishing pad (polishing cloth) can be bonded. As the polishing pad, common nonwoven fabric, polyurethane, porous fluororesin, and the like can be used without particular limitation. The polishing pad is preferably grooved so that it stores the polishing composition. For the polishing conditions, for example, the rotation speed of the polishing table is preferably 10 rpm (0.17 s⁻¹) or more and 500 rpm (8.3 s⁻¹) or less. The pressure (polishing pressure) applied to the object to be polished is preferably 0.5 psi (3.4 kPa) or more and 10 psi (68.9 kPa) or less. The method for feeding the polishing composition to the polishing pad is not particularly limited. For example, a method is utilized in which the polishing composition is continuously fed by a pump or the like. While the feed rate is not limited, it is preferable that the surface of the polishing pad is always covered with the polishing composition.

After completion of the polishing, the substrate is cleaned in running water, and dried by removal of adhered water droplets with a spin dryer or the like to obtain a polished object to be polished.

According to an embodiment of the present invention, the number of defects (more than 0.1 μm) on the polished object to be polished (for example, polished polysilicon) is 250 or less, 200 or less, 170 or less, 150 or less, 130 or less, or 100 or less. Practically, the number of defects is about 10 or more.

### Rinse Composition

An aspect of the present invention is a method for producing a rinse composition, including preparing a liquid A by providing at least one water-soluble polymer-containing liquid containing a water-soluble polymer and water, and filtering the liquid when one water-soluble polymer-containing liquid is provided or filtering a mixture Y when two or more water-soluble polymer-containing liquids are provided; preparing a liquid B by providing at least one chemical component-containing aqueous solution containing a chemical component and water, and filtering the aqueous solution when one chemical component-containing aqueous solution is provided, or filtering a mixture Z containing at least one chemical component-containing aqueous solution; and mixing the liquid A and the liquid B to prepare a liquid C, and filtering the liquid C. Such an aspect can also provide a novel method for producing a rinse composition, which enables reducing coarse particles and enables suppressing generation of defects.

### Step of Preparing Liquid A

A liquid A is prepared by providing at least one water-soluble polymer-containing liquid containing a water-soluble polymer and water, and filtering the liquid when one water-soluble polymer-containing liquid is provided or filtering a mixture Y when two or more water-soluble polymer-containing liquids are provided. The water-soluble polymer mainly has an action of protecting the polished object to be polished, and an action as a wetting agent. The water-soluble polymer is an optional component in the method for producing the polishing composition, but is an essential component in the rinse composition. The rinse composition containing the water-soluble polymer is applied as a post-CMP composition to easily remove foreign matter on the surface of the polished object to be polished, which has been polished with the polishing composition.

In an embodiment of the present invention, the weight average molecular weight of the water-soluble polymer can be 1,000 to 3,000,000, 2,000 to 2,000,000, or 3,000 to 1,500,000. When two or more water-soluble polymers are provided, the weight average molecular weights of the water-soluble polymers may be the same, or at least partially different.

According to an embodiment of the present invention, the concentration of the water-soluble polymer in the water-soluble polymer-containing liquid can be 0.1 to 5 mass %, 0.3 to 3 mass %, or 0.5 to 2 mass %. When two or more water-soluble polymers are provided, the concentrations of the water-soluble polymers in the water-soluble polymer-containing liquid may be the same, or at least partially different.

According to an embodiment of the present invention, the water-soluble polymer present in at least one of the water-soluble polymer-containing liquids has a radius of inertia of 10 nm or more, 50 nm or more, 80 nm or more, or 100 nm or more. When the composition contains a significantly large water-soluble polymer as described above, the present invention particularly markedly exhibits the effect. According to an embodiment of the present invention, the water-soluble polymer present in at least one of the water-soluble polymer-containing liquids has a radius of inertia of 300 nm or less, 250 nm or less, 200 nm or less, or 180 nm or less. The radius of inertia can be calculated by the measurement method described in Examples. When two or more water-soluble polymers are provided, the radii of inertia of the water-soluble polymers in the water-soluble polymer-containing liquid may be the same, or at least partially different.

Details of the “water-soluble polymer” and the “water-soluble polymer-containing liquid” applied to the rinse composition, other than those described in the present section, are as described in <Method for Producing Polishing Composition>.

In the present step, the liquid A is prepared by providing at least one water-soluble polymer-containing liquid containing a water-soluble polymer and water, and filtering the liquid when one water-soluble polymer-containing liquid is provided or filtering a mixture Y when two or more water-soluble polymer-containing liquids are provided. That is, the mixture Y includes the two or more water-soluble polymer-containing liquids.

The material of the filter for filtering at least one of the water-soluble polymer-containing liquid and the mixture Y is not particularly limited, and examples thereof include resins such as polycarbonate, mixed cellulose esters, polyvinylidene fluoride (PVDF), polytetrafluoroethylene (PTFE), ethylene-tetrafluoroethylene copolymers, polycarbonate, polyethersulfone, cellulose acetate, nitrocellulose, regenerated cellulose, polyamide, triacetylcellulose, polypropylene, polyvinyl chloride (PVC), nylon, nylon 66, polysulfone, polyester, polypropylene/polyethylene, acrylic copolymers, polycarbonate, polylactic acid, polycaprolactone, polyglycolic acid, polydioxanone, polyhydroxy butyrate, polybutadiene, polyurethane, polystyrene (PS), polymethyl methacrylate, and polycarbonate, glass, and metals. Among them, nylon and nylon 66 are preferable from the viewpoint of cost and high resistance to chemicals.

The pore size of the filter is not particularly limited, but is preferably 0.03 μm or more, 0.04 μm or more, 0.05 μm or more, or 0.1 μm or more. The pore size of the filter can be 10.0 μm or less, 8.0 μm or less, 5.0 μm or less, 4.0 μm or less, 3.0 μm or less, 2.5 μm or less, 2.1 μm or less, 1.5 μm or less, 1.2 μm or less, 0.9 μm or less, 0.7 μm or less, 0.5 μm or less, or 0.3 μm or less. In particular, when the thickness is 0.7 μm or less, 0.5 μm or less, or 0.3 μm or less, aggregates that can be generated in at least one of the water-soluble polymer-containing liquid and the mixture Y can be efficiently removed.

The form of the filter is not particularly limited. Filters having different structures, shapes, and functions can be appropriately utilized. As a specific example, a filter of pleated type, depth type, depth-pleated type, membrane type, or adsorption type is preferably utilized. The structure of the filter is not particularly limited, and may be in the form of a bag having a bag shape, or a cartridge having a hollow cylinder shape. The cartridge filter may be of gasket type or ring type.

The filtration method for performing filtering may be any of natural filtration performed at ordinary pressure, suction filtration, pressure filtration, and centrifugal filtration, but is preferably pressure filtration in view of productivity.

The filtration rate of the filtering is preferably 30 to 100,000 ml/min (m), 50 to 50,000 ml/min (m), 60 to 10,000 ml/min (m), 80 to 10,000 ml/min (m), 90 to 1,000 ml/min (m), or 100 to 500 ml/min (m).

The filtering time is preferably 1 to 100 minutes, 3 to 50 minutes, or 5 to 30 minutes. As the filter, a commercially available product can also be used in the present step. Examples of the commercially available filter for use in the present step include ULTIPLEAT (registered trademark) P-nylon 66 and ULTIPORE (registered trademark) N66 manufactured by Nihon Pall Ltd.

### Step of Preparing Liquid B

A liquid B is prepared by providing at least one chemical component-containing aqueous solution containing a chemical component and water, and filtering the aqueous solution when one chemical component-containing aqueous solution is provided, or filtering a mixture Z containing at least one chemical component-containing aqueous solution.

### Chemical Component-Containing Aqueous Solution

The chemical component-containing aqueous solution contains a chemical component and water. The chemical component can have an action of suppressing generation of defects by treating the surface of the polished object to be polished. Herein, the chemical component is a concept that abrasive grains, a water-soluble polymer, and a non-aqueous additive which is liquid at 25° C. are excluded. As the chemical component, components which are commonly used in the art can be used without particular limitation.

The method for preparing the mixture Z is not limited as long as it contains at least one chemical component-containing aqueous solution.

The mixture Z is provided by, for example, mixing two or more chemical component-containing aqueous solutions with each other.

In addition, the mixture Z may be prepared by first providing one chemical component-containing aqueous solution, and mixing the chemical component-containing aqueous solution with at least one selected from the group consisting of a chemical component (which is not in the form of an aqueous solution) and a non-aqueous additive which is liquid at 25° C.

In addition, the mixture Z may be prepared by mixing a chemical component (which is not in the form of an aqueous solution), at least one selected from the group consisting of a chemical component (which is not in the form of an aqueous solution) and a non-aqueous additive which is liquid at 25° C., and water. In this case, at least one chemical component-containing aqueous solution containing a chemical component and water are provided in parallel to preparation of the mixture Z.

The mass ratio of the components for preparing the mixture Z can vary depending on the characteristics of an intended rinse composition, and for example, when an organic carboxylic acid such as iminodiacetic acid and an amine such as 2-amino-2-ethyl-1,3-propanediol, the mixing mass ratio is preferably, for example, 26 to 46:54 to 74, or 30 to 40:60 to 70. Note that the value is selected such that the sum is 100. According to an embodiment of the present invention, the total mass of the chemical components with respect to the mass of the mixture Z is preferably 3 to 15 mass % or 5 to 10 mass %.

According to an embodiment of the present invention, the chemical component used to prepare at least one chemical component-containing aqueous solution is solid at 25° C. The present inventors have found that, in particular, if a chemical component-containing aqueous solution containing a chemical component which is solid at 25° C. and water is used for preparation of a rinse composition, a desired effect of the present invention cannot be obtained even when filtering is performed immediately before an end product of the polishing composition is obtained (that is, even when the liquid C is filtered). The present inventors presume that this is because the chemical component which is solid at 25° C. is not completely dissolved and remains in the chemical component-containing aqueous solution. This is particularly marked in preparation of the mixture Z. Thus, by filtering the chemical component-containing aqueous solution (in particular, the mixture Z), a desired effect of the present invention can be more efficiently obtained.

According to an embodiment of the present invention, the chemical component used to prepare at least one chemical component-containing aqueous solution is in a liquid form at 25° C. According to an embodiment of the present invention, the mixture Z is prepared by providing a chemical component which is in a liquid form at 25° C., and mixing the chemical component which is in a liquid form at 25° C. with the chemical component-containing aqueous solution without filtering the chemical component in advance. According to such an embodiment, there is the effect of enabling improvement of productivity while securing quality.

According to an embodiment of the present invention, the concentration of the chemical component in the chemical component-containing aqueous solution can be 0.1 to 20 mass %, 0.2 to 15 mass %, or 0.5 to 12 mass %. When two or more chemical component-containing aqueous solutions are provided, the concentrations of the chemical components in the chemical component-containing aqueous solution may be the same, or at least partially different.

Details of the “chemical component-containing aqueous solution” mixed with the rinse composition, other than those described in the present section, are as described in <Method for Producing Polishing Composition>.

### Non-Aqueous Additive Which Is Liquid at 25° C.

A non-aqueous additive which is liquid at 25° C. may also be added to the rinse composition for the purpose of imparting certain characteristics.

According to an embodiment of the present invention, the mixture Z is prepared by providing a non-aqueous additive which is liquid at 25° C., and mixing the non-aqueous additive with the chemical component-containing aqueous solution without prior filtration of the non-aqueous additive. According to such an embodiment, there is the effect of enabling improvement of productivity while securing quality. Thus, for production of the rinse composition, it is possible to provide a production method capable of securing both quality and productivity by selecting an object to be filtered on the basis of a clear technical idea instead of performing filtering with respect to all components without reason.

In an embodiment of the present invention, the weight average molecular weight of the non-aqueous additive which is liquid at 25° C. is preferably 50 to 5,000, more preferably 120 to 2,000, and still more preferably 150 to 1,000.

Details of the “non-aqueous additive which is liquid at 25° C.”, which is mixed with the rinse composition, other than those described in the present section, are as described in <Method for Producing Polishing Composition>.

Details of the filtering of at least one of the chemical component-containing aqueous solution and the mixture Z are as described for the filtering of at least one of the water-soluble polymer-containing liquid and the mixture Y. However, the filtration rate in the filtering of at least one of the chemical component-containing aqueous solution and the mixture Z is preferably higher than the filtration rate adopted in the filtering of at least one of the water-soluble polymer-containing liquid and the mixture Y. According to an embodiment of the present invention, the filtration rate in the filtering of at least one of the chemical component-containing aqueous solution and the mixture Z is preferably 100 to 300,000 ml/min (m), 200 to 100,000 ml/min (m), or 300 to 10,000 ml/min (m).

### Step of Preparing Liquid C and Filtering the Liquid C

The liquid C can be prepared by mixing the liquid A and the liquid B. Here, water can be mixed in addition to the liquid A and the liquid B. In an embodiment of the present invention, the mixing mass ratio of the liquid A, the liquid B and water can vary depending on the characteristics of an intended polishing composition, and is preferably, for example, 1 to 20:50 to 200:800 to 920, or 5 to 15:70 to 150:800 to 900. Note that the value is selected such that the sum is 1,000. The mixing method is not particularly limited, and for example, the mixture can be prepared by use of a well-known mixing device such as a propeller stirrer, an ultrasonic disperser, or a homomixer. The respective liquids for the rinse composition may be mixed at the same time, or may be mixed in an arbitrary sequence.

The rinse composition can be produced by filtering the liquid C in the present step. Details of the filtering of the liquid C is as described for the filtering of at least one of the water-soluble polymer-containing liquid and the mixture Y. However, the filtration rate in the filtering of the liquid C is preferably higher than the filtration rate adopted in the filtering of at least one of the water-soluble polymer-containing liquid and the mixture Y, and preferably lower than the filtration rate in the filtering of at least one of the chemical component-containing aqueous solution and the mixture Z. According to an embodiment of the present invention, the filtration rate in the filtering of the liquid C is preferably 100 to 300,000 ml/min (m), 200 to 100,000 ml/min (m), or 300 to 10,000 ml/min (m).

In the polishing composition thus produced, the number of coarse particles having a particle size of more than 0.15 μm can be 1,200,000 or less, 1,000,000 or less, 800,000 or less, or 600,000 or less per 1 ml of the rinse composition. The method for measuring the coarse particles follows the method described in Examples.

In an embodiment of the present invention, the content of the abrasive grains in the rinse composition is less than 0.1 mass %, less than 0.01 mass %, or less than 0.001 mass %. In an embodiment of the present invention, the rinse composition is substantially free of abrasive grains. The phrase “substantially free of abrasive grains” means that abrasive grains are not contained, or contained at a concentration of less than 0.0001 mass %. In an embodiment of the present invention, the rinse composition is free of abrasive grains.

The rinse composition of the present invention may be of one-component type or multi-component type such as two-component type. In addition, the rinse composition of the present invention may be prepared by diluting a stock solution of the polishing composition, for example, 10-fold or more with a diluent such as water.

### Application of Rinse Composition

The rinse composition according to the present invention is preferably used in rinse treatment for removing foreign matter that can exist on the surface of the polished object to be polished, which is obtained by polishing the object to be polished, with the polishing composition. Details of the object to be polished are as described in <Method for Producing Polishing Composition>.

The polishing composition may be, or is not required to be, a polishing composition prepared by the method for producing a polishing composition according to the present invention. Hereinafter, the polishing composition which is not prepared by the production method of the present invention will be described.

Common polishing compositions can be used without limitation.

According to an embodiment of the present invention, the polishing composition contains abrasive grains and water, and may contain, if necessary, at least one selected from the group consisting of a chemical component, a water-soluble polymer, and a non-aqueous additive which is liquid at 25° C.

According to an embodiment of the present invention, the content (concentration) of the abrasive grains in the polishing composition is, for example, 0.1 to 20 mass %, 0.3 to 15 mass %, or 0.5 to 10 mass %. When the polishing composition contains two or more kinds of abrasive grains, the content of the abrasive grains means the total amount of these abrasive grains. According to an embodiment of the present invention, the content (concentration) of the chemical component in the polishing composition is, for example, 0.1 to 10 mass %, 0.3 to 0.5 mass %, or 0.5 to 3 mass %. When the polishing composition contains two or more chemical components, the content of the chemical component means the total amount of these chemical components. According to an embodiment of the present invention, the content (concentration) of the water-soluble polymer in the polishing composition is, for example, 0.0001 to 10 mass %, 0.001 to 5 mass %, or 0.01 to 1 mass %. When the polishing composition contains two or more water-soluble polymers, the content of the water-soluble polymer means the total amount of these water-soluble polymers. According to an embodiment of the present invention, the content (concentration) of the non-aqueous additive which is liquid at 25° C. is, for example, 0.0001 to 3 mass %, 0.001 to 1 mass %, or 0.01 to 0.5 mass %, in the polishing composition. When the polishing composition contains two or more non-aqueous additives, the content of the non-aqueous additive which is liquid at 25° C. is means the total amount of these non-aqueous additives.

The abrasive grain may be any of an inorganic particle, an organic particle, and an organic-inorganic composite particle. Specific examples of the inorganic particle include particles of metal oxides such as silica, alumina, ceria and titania, silicon nitride particles, silicon carbide particles, and boron nitride particles. Specific examples of the organic particle include polymethyl methacrylate (PMMA) particles. One type of abrasive grains may be used, or two or more types of abrasive grains may be used in combination. For the abrasive grain, a commercially available product or a synthetic product may be used. The abrasive grain is preferably that of silica, particularly preferably colloidal silica.

According to an embodiment of the present invention, 85 mass % or more, 90 mass % or more, 95 mass % or more, 98 mass % or more, or 99 mass % or more of the particles forming the abrasive grains are composed of silica (particularly colloidal silica) (the upper limit is 100 mass %).

The shape of the abrasive grain is not particularly limited, and may be spherical or non-spherical. Specific examples of the non-spherical shape include various shapes such as the shapes of polygonal prisms such as triangular prism and a quadrangular prism, a cylindrical shape, a straw bag shape in which a central portion of a cylinder has a larger size over an end portion thereof, a donut shape which is disk-shaped with a hole in the center, a plate shape, a so-called cocoon shape having a constriction at a central portion, a so-called associated spherical shape in which a plurality of particles are integrated, the shape of so-called kompeito which has a plurality of protrusions on a surface thereof, and a rugby ball shape, and are not particularly limited.

When colloidal silica is used as the abrasive grain, the surface of the colloidal silica may be surface-modified with a silane coupling agent or the like.

Examples of the method for surface-modifying the surface of colloidal silica with a silane coupling agent include the following immobilization method.

For example, the surface modification can be performed by a method described in “Sulfonic acid-functionalized silica through quantitative oxidation of thiol groups”, Chem. Commun. 246-247 (2003). Specifically, a silane coupling agent having a thiol group, such as 3-mercaptopropyltrimethoxysilane, is coupled to colloidal silica, and the thiol group is then oxidized with hydrogen peroxide, whereby colloidal silica having sulfonic acid immobilized on the surface thereof can be obtained. Alternatively, the surface modification can be performed by, for example, a method described in “Novel Silane Coupling Agents Containing a Photolabile 2-Nitrobenzyl Ester for Introduction of a Carboxy Group on the Surface of Silica Gel”, Chemistry Letters, 3,228-229 (2000). Specifically, a silane coupling agent containing a 2-nitrobenzyl ester having photoreactivity is coupled to colloidal silica, followed by light irradiation, whereby colloidal silica having a carboxylic acid immobilized on the surface thereof can be obtained.

While colloidal silica having an anionic group (anionically modified colloidal silica) is described above, colloidal silica having a cationic group (cationically modified colloidal silica) may be used. Examples of the colloidal silica having a cationic group include colloidal silica having an amino group is immobilized on the surface thereof. Examples of the method for producing the colloidal silica having a cationic group include a method in which a silane coupling agent having an amino group, such as aminoethyltrimethoxysilane, aminopropyltrimethoxysilane, aminoethyltriethoxysilane, aminopropyltriethoxysilane, aminopropyldimethylethoxysilane, aminopropylmethyldiethoxysilane or aminobutyltriethoxysilane, is immobilized on the surface of the colloidal silica as described in JP 2005-162533 A. In this way, colloidal silica having an amino group immobilized on the surface thereof can be obtained.

The size of the abrasive grains is not particularly limited. For example, the average primary particle size of the abrasive grains is preferably 5 nm or more, more preferably 10 nm or more, and still more preferably 15 nm or more. In addition, the average primary particle size of the abrasive grains is preferably 120 nm or less, more preferably 80 nm or less, and still more preferably 50 nm or less. That is, the average primary particle size of the abrasive grains is preferably 5 nm or more and 120 nm or less, more preferably 10 nm or more and 80 nm or less, and still more preferably 15 nm or more and 50 nm or less. The average primary particle size of the abrasive grains can be calculated from, for example, a specific surface area (SA) of the abrasive grains which is calculated by a BET method, where the shape of the abrasive grain is assumed to be perfectly spherical. Herein, as the average primary particle size of the abrasive grains, a value measured by the method described in Examples is adopted.

In addition, the average secondary particle size of the abrasive grains is preferably 30 nm or more, more preferably 40 nm or more, and still more preferably 50 nm or more. In addition, the average secondary particle size of the abrasive grains is preferably 250 nm or less, more preferably 200 nm or less, and still more preferably 150 nm or less. That is, the average secondary particle size of the abrasive grains is preferably 30 nm or more and 250 nm or less, more preferably 40 nm or more and 200 nm or less, and still more preferably 50 nm or more and 150 nm or less. The average secondary particle size of the abrasive grains can be measured by, for example, a dynamic light scattering method typified by a laser diffraction scattering method. Herein, as the average secondary particle size of the abrasive grains, a value measured by the method described in Examples is adopted.

The average degree of association of the abrasive grains is preferably 5.0 or less, more preferably 4.0 or less, and still more preferably 3.0 or less. As the average degree of association of the abrasive grains decreases, defects can be reduced. The average degree of association of the abrasive grains is preferably 1.0 or more, more preferably 1.5 or more, and still more preferably 2.0 or more. The average degree of association is obtained by dividing the value of the average secondary particle size of the abrasive grains by the value of the average primary particle size. As the average degree of association of the abrasive grains increases, the polishing removal rate in an object to be polished with the polishing composition is improved, which is an advantageous effect.

The upper limit of the aspect ratio of the abrasive grains is not particularly limited, but is preferably less than 2.0, more preferably 1.8 or less, and still more preferably 1.5 or less. When the above-mentioned upper limit is in such a range, defects on the surface of the object to be polished can be further reduced. The aspect ratio is an average of values obtained by identifying, under a scanning microscope, the smallest rectangle circumscribed around an image of an abrasive grain particle, and dividing the length of the long side of the rectangle by the length of the short side of the rectangle, and can be determined by use of common image analysis software. The lower limit of the aspect ratio of the abrasive grains in the polishing composition is not particularly limited, but is preferably 1.0 or more.

In a particle size distribution of the abrasive grains which is determined by a laser diffraction scattering method, the lower limit of D90/D10, which is a ratio between a particle diameter at which the cumulative particle mass reaches 90% of the mass of all particles (D90) and a particle diameter at which the cumulative particle mass reaches 10% of the mass of all particles (D10) with respect to the smallest particle size, is not particularly limited, but is preferably 1.1 or more, more preferably 1.2 or more, and still more 1.3 or more. In a particle size distribution of the abrasive grains which is determined by a laser diffraction scattering method, the upper limit of the ratio between a particle diameter at which the cumulative particle mass reaches 90% of the mass of all particles (D90) and a particle diameter at which the cumulative particle mass reaches 10% of the mass of all particles (D10), D90/D10, with respect to the smallest particle size, is not particularly limited, but is preferably 2.0 or less. When the above-mentioned upper limit is in such a range, defects on the surface of the object to be polished can be further reduced.

The sizes (average primary particle size, average secondary particle size, aspect ratio, D90/D10 and the like) of the abrasive grains can be appropriately controlled by, for example, selecting a method for producing abrasive grains.

The chemical component has an action of chemically polishing an object to be polished. Herein, the chemical component is a concept that abrasive grains, a water-soluble polymer, and a non-aqueous additive which is liquid at 25° C. are excluded. As the chemical component, components which are commonly used in the art can be used without particular limitation. As the chemical component-containing aqueous solution, at least one chemical component-containing aqueous solution are provided.

According to an embodiment of the present invention, the chemical component is an organic acid, an inorganic acid, an organic acid salt, an inorganic acid salt, a saccharide, or the like. Examples of the salt include alkali metal salts and ammonium salts of sodium, potassium and the like.

Examples of the organic acid include organic carboxylic acids such as citric acid, maleic acid, malic acid, glycolic acid, succinic acid, itaconic acid, malonic acid, iminodiacetic acid, gluconic acid, lactic acid, mandelic acid, tartaric acid, formic acid, acetic acid, propionic acid, butyric acid, adipic acid, oxalic acid, valeric acid, enanthic acid, caproic acid, caprylic acid, pelargonic acid, capric acid, lauric acid, myristic acid, palmitic acid, margaric acid, stearic acid, cyclohexanecarboxylic acid, phenylacetic acid, benzoic acid, crotonic acid, oleic acid, linoleic acid, linolenic acid, ricinolenic acid, methacrylic acid, glutaric acid, fumaric acid, phthalic acid, isophthalic acid, terephthalic acid, tartronic acid, glyceric acid, hydroxybutyric acid, hydroxyacetic acid, hydroxybenzoic acid, salicylic acid, isocitric acid, methylenesuccinic acid, gallic acid, ascorbic acid, nitroacetic acid, oxaloacetic acid, chloroacetic acid, dichloroacetic acid and trichloroacetic acid; amino acids such as glycine, alanine, glutamic acid, aspartic acid, valine, leucine, isoleucine, serine, threonine, cysteine, methionine, phenylalanine, tryptophan, tyrosine, proline, cystine, glutamine, asparagine, lysine and arginine; nicotinic acid; picric acid; picolinic acid; phytic acid; organic phosphonic acids such as 1-hydroxyethylidene-1,1-diphosphonic acid, aminotri (methylenephosphonic acid), ethylenediamine tetra(methylenephosphonic acid), diethylenetriamine penta(methylenephosphonic acid), ethane-1,1-diphosphonic acid, ethane-1,1,2-triphosphonic acid, ethane-1-hydroxy-1,1-diphosphonic acid, ethanehydroxy-1,1,2-triphosphonic acid, ethane-1,2-dicarboxy-1,2-diphosphonic acid, methanehydroxyphosphonic acid, 2-phosphonobutane-1,2-dicarboxylic acid, 1-phosphonobutane-2,3,4-tricarboxylic acid, α-tetraphenylphosphonium acid and aminopoly (methylenephosphonic acid); and organic sulfonic acids such as xylenesulfonic acid, methanesulfonic acid, ethanesulfonic acid, aminoethanesulfonic acid, benzenesulfonic acid, p-toluenesulfonic acid, 2-naphthalenesulfonic acid, sulfosuccinic acid, 10-camphorsulfonic acid, isethionic acid and taurine.

Examples of the inorganic acid include phosphoric acid (orthophosphoric acid), nitric acid, sulfuric acid, hydrochloric acid, boric acid, sulfamic acid, phosphinic acid, phosphonic acid, pyrophosphoric acid, tripolyphosphoric acid, tetrapolyphosphoric acid, hexametaphosphoric acid, carbonic acid, hydrofluoric acid, sulfurous acid, thiosulfuric acid, chloric acid, perchloric acid, chlorous acid, hydroiodic acid, periodic acid, iodic acid, hydrobromic acid, perbromic acid, bromic acid, chromic acid, and nitrous acid.

Examples of the saccharide include monosaccharides such as tetrose such as erythrose, threose and erythrulose; pentose such as ribose, arabinose, xylose, lyxose, xylulose and ribulose; and hexose such as allose, altrose, glucose, mannose, gulose, idose, galactose, talose, fructose, sorbose, psicose and tagatose; and oligosaccharides such as maltose, isomaltose, cellobiose, gentiobiose, melibiose, lactose, turanose, trehalose, saccharose, mannitriose, cellotriose, gentianose, raffinose, melezitose, cellotetrose and stachyose. In addition, other saccharides may be used, for example, heptose, deoxy sugars, thio sugars, seleno sugars, aldonic sugars, uronic acid, sugar acids, ketoaldonic acid, anhydrosugars, unsaturated sugars, sugar esters, sugar ethers, and residues such as glycosides, or polysaccharides such as starch, glycogen, cellulose, chitin and chitosan, or hydrolyzed products thereof.

Specific examples of the basic compound include hydroxides or salts of alkali metals, quaternary ammonium hydroxides or salts thereof, ammonia, and amines. Examples of the alkali metal include potassium and sodium. Examples of the salt include carbonates, hydrogencarbonates, sulfates, and acetates. Examples of the quaternary ammonium include tetramethylammonium, tetraethylammonium, and tetrabutylammonium.

The quaternary ammonium hydroxide compound includes quaternary ammonium hydroxide or a salt thereof, and specific examples thereof include tetramethylammonium hydroxide, tetraethylammonium hydroxide, and tetrabutylammonium hydroxide.

Specific examples of the amine include 2-amino-2-ethyl-1,3-propanediol, methylamine, dimethylamine, trimethylamine, ethylamine, diethylamine, triethylamine, ethylenediamine, monoethanolamine, N-(β-aminoethyl)ethanolamine, hexamethylenediamine, diethylenetriamine, triethylenetetramine, anhydrous piperazine, piperazine hexahydrate, 1-(2-aminoethyl)piperazine, N-methylpiperazine, and guanidine. These basic compounds may be used alone, or in combination of two or more thereof.

According to an embodiment of the present invention, the chemical component is solid at 25° C.

The water-soluble polymer mainly has an action of protecting an object to be polished, and an action as a wetting agent. Therefore, the water-soluble polymer may be added to the polishing composition.

Herein, the water-soluble polymer is solid (powder form) at 25° C., and can be dissolved in water to form a liquid. The water-soluble polymer-containing liquid can be prepared by dissolving the water-soluble polymer in water. Here, the term “water-soluble” means that the solubility in water (25° C.) is 1 g/100 mL or more, and the term “polymer” refers to a (co) polymer containing a repeat unit in its molecular structure and having a weight average molecular weight (Mw) of 1,000 or more.

As the water-soluble polymer, one having at least one functional group selected from a cationic group, an anionic group and a nonionic group in the molecule can be used. Specific examples of the water-soluble polymer include those containing a hydroxyl group, a carboxyl group, an acyloxy group, a sulfo group, a quaternary ammonium structure, a heterocyclic structure, a vinyl structure, a polyoxyalkylene structure, or the like in the molecule. Preferred examples thereof include polymers containing a nitrogen atom, polyvinyl alcohol (polyvinyl alcohol having a saponification degree of 70 mol % or more), and cellulose derivatives. The term “cellulose derivative” means a derivative of cellulose in which at least one of hydroxyl groups of water-insoluble cellulose is replaced by a substituent to impart water-solubility. Here, cellulose is obtained by linear polymerization of a large number of β-glucose molecules via glycoside bonds. The constituent unit of cellulose has hydroxyl groups at positions C2, C3 and C6. Since the hydroxyl group forms strong hydrogen bonding in a molecule and between molecules, cellulose is generally insoluble in water or an organic solvent. However, the cellulose derivative can be made soluble in water by replacing at least a part of hydroxyl groups of cellulose by a substituent and cleaving at least a part of the hydrogen bonding.

More specific examples include cellulose derivatives, imine derivatives such as poly (N-acylalkyleneimine), polyvinyl alcohol, polyvinyl pyrrolidone, copolymers containing polyvinyl pyrrolidone as a part of the structure, polyvinyl caprolactam, copolymers containing polyvinyl caprolactam as a part of the structure, polyoxyethylene, polymers containing an oxyalkylene unit, these polymers arranged in a diblock form, a triblock form, a random form, an alternate form or the like to form a polymer having a plurality of structures, and polyether-modified silicone.

Among them, cellulose derivatives, polyvinyl alcohol, polyvinyl pyrrolidone, or polymers containing an oxyalkylene unit are preferable from the viewpoint of well serving to impart hydrophilicity. Specific examples of the cellulose derivative include cellulose derivatives such as hydroxyethyl cellulose, hydroxypropyl cellulose, hydroxyethyl methyl cellulose, methyl cellulose, hydroxypropyl methyl cellulose, ethyl cellulose, ethyl hydroxyethyl cellulose and carboxymethyl cellulose, and pullulan. Among the cellulose derivatives, hydroxyethyl cellulose is preferable from the viewpoint of high ability to impart wettability to the polished surface, and good cleaning properties.

In an embodiment of the present invention, the weight average molecular weight of the water-soluble polymer is preferably 1,000 to 3,000,000, more preferably 2,000 to 1,000,000, still more preferably 3,000 to 500,000, more preferably 5,000 to 100,000, and even more preferably 8,000 to 50,000. When two or more water-soluble polymers are provided, the weight average molecular weights of the water-soluble polymers may be the same, or at least partially different.

The non-aqueous additive which is in a liquid form at 25° C. is a non-aqueous additive which is in a liquid form at 25° C. even when it is not dissolved in water.

According to an embodiment of the present invention, the non-aqueous additive which is liquid at 25° C. contains an oxyalkylene unit. Examples of the compound containing an oxyalkylene unit include ethylene glycol, propylene glycol, polyethylene glycol (polyethylene oxide (PEO)), polypropylene glycol (propylene oxide (PO)), block copolymers of ethylene oxide (EO) and propylene oxide (PO), and random copolymers of EO and PO. The block copolymer of EO and PO can be a diblock form or a triblock form containing a polyethylene oxide (PEO) block and a polypropylene oxide (PPO) block. The triblock form includes a PEO-PPO-PEO triblock form and a PPO-PEO-PPO triblock form. Normally, a PEO-PPO-PEO triblock form is more preferable. In the block copolymer or the random copolymer of EO and PO, the molar ratio of EO and PO forming the copolymer (EO/PO) is preferably more than 1, more preferably 2 or more, and still more preferably 3 or more (for example, 5 or more), from the viewpoint of solubility in water and the like.

In an embodiment of the present invention, the weight average molecular weight of the non-aqueous additive which is liquid at 25° C. is preferably 50 to 5,000, more preferably 120 to 2,000, and still more preferably 150 to 1,000.

According to an embodiment of the present invention, examples of the non-aqueous additive which is liquid at 25° C. include alcohols (for example, methanol and ethanol).

An object to be polished is polished with the above-described polishing composition, whereby a polished object to be polished can be obtained. The rinse treatment is performed by applying a rinse composition according to the present invention to the polished object to be polished. In one embodiment of the present invention, the rinse treatment can be performed on a polishing table (platen) on which a polishing pad is attached. Here, the rinse composition is brought into direct contact with the polished object to be polished. As a result, foreign matter on the surface of the polished object to be polished is removed by a force of friction with the polishing pad (physical action) and a chemical action of the rinse composition. Among the foreign matters, particles and organic residues are particularly easily removed by the physical action. Therefore, in a preferred rinse treatment, particles and organic residues can be effectively removed by utilizing friction with the polishing pad on the polishing table (platen). That is, the rinse treatment using the rinse composition is preferably a treatment for reducing residues on the surface of the polished object to be polished, by use of the polishing pad.

Specifically, for example, the rinse treatment can be performed by placing the surface of the polished object to be polished on a polishing table (platen) of a polishing apparatus, bringing the polishing pad into contact with the polished object to be polished, and relatively sliding the polished object to be polished and the polishing pad while feeding the rinse composition to the contact portion between the polishing pa d and the polished object to be polished.

As the polishing apparatus, a common polishing apparatus can be used which is equipped with a holder for holding an object to be polished, a motor capable of changing the number of rotations, and the like, and includes a polishing table to which a polishing pad (polishing cloth) can be bonded.

As the polishing pad, common nonwoven fabric, polyurethane, porous fluororesin, and the like can be used without particular limitation. The polishing pad is preferably grooved so that it stores the rinse composition.

The rinse polishing conditions are not particularly limited. For example, the rotation speed of the polishing table and the rotation speed of the head (carrier) are preferably 10 rpm (0.17 s⁻¹) or more and 100 rpm (1.67 s⁻¹) or less, and the pressure (polishing pressure) applied to the polished object to be polished is preferably 0.5 psi (3.4 kPa) or more and 10 psi (68.9 kPa) or less. The method for feeding the rinse composition to the polishing pad is not particularly limited. For example, a method is utilized in which the polishing composition is continuously fed by a pump or the like (non-cyclic flow). While the feed rate is not limited, it is preferable that the surface of the polishing pad is always covered with the rinse composition. The feed rate is preferably 10 mL/min or more and 5,000 mL/min or less. The rinse time is not particularly limited, but is preferably 5 seconds or more and 180 seconds or less.

According to an embodiment of the present invention, the number of defects (more than 0.1 μm) on the rinsed object to be rinsed (for example, rinsed polysilicon) is 170 or less, 150 or less, 130 or less, or 100 or less. Practically, the number of defects is about 10 or more.

The present invention has the following aspects and forms.
1. A method for producing a polishing composition, including preparing a first liquid by providing an abrasive grain dispersion containing abrasive grains and water, and filtering the abrasive grain dispersion; preparing a second liquid by providing at least one chemical component-containing aqueous solution containing a chemical component and water, and filtering the aqueous solution when one chemical component-containing aqueous solution is provided, or filtering a mixture X containing at least one chemical component-containing aqueous solution; and mixing the first liquid and the second liquid to prepare a third liquid, and filtering the third liquid.
2. The production method according to 1., in which the abrasive grain contains silica.
3. The production method according to 1. or 2., in which the abrasive grain contains colloidal silica.
4. The production method according to any one of 1. to 3., in which the chemical component used to prepare at least one chemical component-containing aqueous solution is solid at 25° C.
5. The production method according to any one of 1. to 4., in which the mixture X is prepared by providing two or more chemical component-containing aqueous solutions, and filtering at least one of the aqueous solutions, followed by mixing them.
6. The production method according to any one of 1. to 5., in which a number of coarse particles having a particle size of more than 0.15 μm is 1,000,000 or less per 1 ml of the polishing composition.
7. The production method according to any one of 1. to 6., in which the mixture X is prepared by providing at least one water-soluble polymer-containing liquid containing a water-soluble polymer and water, and mixing the water-soluble polymer-containing liquid with the chemical component-containing aqueous solution.
8. The production method according to 7., in which the mixture X is prepared by filtering the water-soluble polymer-containing liquid, followed by mixing them.
9. The production method according to any one of 1. to 8., in which the mixture X is prepared by providing a non-aqueous additive which is liquid at 25° C., and mixing the non-aqueous additive with the chemical component-containing aqueous solution without prior filtration of the non-aqueous additive.
10. A method for producing a rinse composition, including preparing a liquid A by providing at least one water-soluble polymer-containing liquid containing a water-soluble polymer and water, and filtering the liquid when one water-soluble polymer-containing liquid is provided or filtering a mixture Y when two or more water-soluble polymer-containing liquids; preparing a liquid B by providing at least one chemical component-containing aqueous solution containing a chemical component and water, and filtering the aqueous solution when one chemical component-containing aqueous solution is provided, or filtering a mixture Z containing at least one chemical component-containing aqueous solution; and mixing the liquid A and the liquid B to prepare a liquid C, and filtering the liquid C.
11. The production method according to 10., in which the mixture Z is prepared by providing a non-aqueous additive which is liquid at 25° C., and mixing the non-aqueous additive with the chemical component-containing aqueous solution without prior filtration of the non-aqueous additive.
12. The production method according to 10. or 11., in which the water-soluble polymer present in at least one of the water-soluble polymer-containing liquids has a radius of inertia of 10 nm or more.
13. The production method according to any one of 10. to 12., in which a number of coarse particles having a particle size of more than 0.15 μm is 1,000,000 or less per 1 ml of the rinse composition.
14. The production method according to any one of 10 to 13, in which the rinse composition is substantially free of abrasive grains.

### EXAMPLES

The present invention will be described in more detail by giving the following examples and comparative examples. However, the technical scope of the present invention is not limited to the following examples. In addition, in the following, operations were performed under the conditions of room temperature (25° C.) and a relative humidity of 40 to 50% RH unless otherwise specified.

### Provision of Raw Materials

1) As an abrasive grain dispersion, an aqueous dispersion of colloidal silica (concentration of colloidal silica: 20 mass %; average primary particle size of abrasive grains: 12 nm; average secondary particle size of abrasive grains: 25 nm, D90/D10:3.1) was provided. The average primary particle size of the abrasive grains was calculated from a BET method-based specific surface area of the abrasive grains, which had been measured by use of “Flow SorbII 2300” manufactured by Micromeritics Instrument Corporation, and the density of the abrasive grains. The average secondary particle size of the abrasive grains was measured by a dynamic light scattering particle size/particle size distribution device UPA-UT151 manufactured by Nikkiso Co., Ltd.
2) As a chemical component-containing aqueous solution, a maleic acid aqueous solution (concentration of maleic acid: 10 mass %) was provided. A maleic acid is solid (powder form) at 25° C.
3) As a chemical component-containing aqueous solution, a N-methyl-D-glucamine aqueous solution (concentration of N-methyl-D-glucamine: 10 mass %) was provided. A N-methyl-D-glucamine is solid (powder form) at 25° C.
4) As a chemical component-containing aqueous solution, a m-xylenesulfonic acid aqueous solution (concentration of m-xylenesulfonic acid: 10 mass %) was provided. A m-xylenesulfonic acid is solid (powder form) at 25° C.
5) As a non-aqueous additive which is liquid at 25° C., polyethylene glycol (weight average molecular weight: 200) was provided.
6) As a chemical component, iminodiacetic acid was provided. A iminodiacetic acid is solid (powder form) at 25° C.
7) As a chemical component, 2-amino-2-ethyl-1,3-propanediol was provided. A 2-amino-2-ethyl-1,3-propanediol is in a liquid form at 25° C.
8) As a water-soluble polymer-containing liquid, a hydroxyethyl cellulose-containing liquid (concentration of hydroxyethyl cellulose: 1 mass %; radius of inertia of hydroxyethyl cellulose present in hydroxyethyl cellulose-containing liquid: 140 nm; weight average molecular weight of hydroxyethyl cellulose: 1,400,000) was provided. In measurement of the radius of inertia, first, an aqueous solution was prepared such that the concentration of the water-soluble polymer was in the range of 0.1 to 1 mg/mL. For each of the prepared samples, the measurement was performed every 10 degrees over the measurement angle range of 20 to 150 degrees by use of a light scattering photometer “DLS-8000” (manufactured by Otsuka Electronics Co., Ltd.), and the radius of inertia [nm] was calculated by one-concentration method plot analysis.

### Provision of Polishing Composition

### Example 1

The aqueous dispersion of colloidal silica provided in 1) was filtered by pressure filtration at a filtration rate of 500 ml/m for 10 minutes through a 1 inch cartridge filter having a pore size of 3.0 μm (made of polypropylene (depth type)) (manufactured by Roki Techno Co., Ltd.), thereby preparing a first liquid.

The maleic acid aqueous solution, the N-methyl-D-glucamine aqueous solution and the m-xylenesulfonic acid aqueous solution provided in 2), 3) and 4), respectively, were filtered at a filtration rate of 500 ml/m for 10 minutes through a 1-inch cartridge filter having a pore size of 0.2 μm (ULTIPORE (registered trademark) N66 (pleated type), made of nylon 66, manufactured by Nippon Pole Ltd.), thereby providing a filtered maleic acid aqueous solution, a filtered N-methyl-D-glucamine aqueous solution, and a filtered m-xylenesulfonic acid aqueous solution.
The filtered maleic acid aqueous solution,
the filtered aqueous N-methyl-D-glucamine solution,
the filtered aqueous m-xylenesulfonic acid solution, and
the polyethylene glycol provided in 5)
were mixed at a mass ratio of 15:15:45:25 to prepare a mixture X, and the mixture X was filtered by pressure filtration at a filtration rate of 500 ml/m for 10 minutes through a 1 inch cartridge filter having a pore size of 0.2 μm (ULTIPORE (registered trademark) N66 (pleated type), made of nylon 66, manufactured by Nippon Pole Ltd.), thereby preparing a second liquid.

The first liquid, the second liquid and water were mixed at a mass ratio of 300:100:600 to prepare a third liquid, and the third liquid was filtered by pressure filtration at a filtration rate of 500 ml/m for 10 minutes through a 1-inch cartridge filter having a pore size of 3.0 μm (made of polypropylene (depth type)) (manufactured by Roki Techno Co., Ltd.). The thus-obtained liquid was filtered by pressure filtration at a filtration rate of 200 ml/m for 10 minutes through a 1-inch cartridge filter having a pore size of 0.2 μm (ULTIPORE (registered trademark) N66 (pleated type), made of nylon 66, manufactured by Nippon Pole Ltd.), thereby preparing a composition. Water was added so as to triple the mass of the composition (that is, diluted 3-fold with water), thereby preparing a polishing composition.

### Example 2

A polishing composition was prepared in the same manner as in Example 1 except that with respect to Example 1, the polyethylene glycol provided in 5) was further filtered by pressure filtration at a filtration rate of 200 ml/m for 10 minutes through a 1 inch cartridge filter having a pore size of 0.2 μm (ULTIPORE (registered trademark) N66 (pleated type), made of nylon 66, manufactured by Nippon Pole Ltd.).

### Example 3

The aqueous dispersion of colloidal silica provided in 1) was filtered by pressure filtration at a filtration rate of 500 ml/m for 10 minutes through a 1 inch cartridge filter having a pore size of 3.0 μm (made of polypropylene (depth type)) (manufactured by Roki Techno Co., Ltd.), thereby preparing a first liquid.

The maleic acid aqueous solution,
the polyethylene glycol (weight average molecular weight: 200), and
the iminodiacetic acid
provided in 2), 5) and 6), respectively,
were taken at a mass ratio of 86:10: 4, and mixed with water to prepare a mixture X at a total mass concentration of 10 mass %, and the mixture X was filtered by pressure filtration at a filtration rate of 500 ml/m for 10 minutes through a 1 inch cartridge filter having a pore size of 0.2 um (ULTIPORE (registered trademark) N66 (pleated type), made of nylon 66, manufactured by Nippon Pole Ltd.), thereby preparing a second liquid.

The first liquid, the second liquid and water were mixed at a mass ratio of 50:100: 850 to prepare a third liquid, and the third liquid was filtered by pressure filtration at a filtration rate of 500 ml/m for 10 minutes through a 1-inch cartridge filter having a pore size of 3.0 μm (manufactured by Roki Techno Co., Ltd.). The thus-obtained liquid was filtered by pressure filtration at a filtration rate of 200 ml/m for 10 minutes through a 1-inch cartridge filter having a pore size of 0.2 μm (ULTIPORE (registered trademark) N66 (pleated type), made of nylon 66, manufactured by Nippon Pole Ltd.), thereby preparing a polishing composition.

### Example 5

A polishing composition was prepared in the same manner as in Example 1 except that with respect to Example 1, the m-xylene sulfonic acid aqueous solution provided in 4) was used instead of the filtered m-xylene sulfonic acid aqueous solution.

### Example 6

A polishing composition was prepared in the same manner as in Example 1 except that with respect to Example 1, the N-methyl-D-glucamine aqueous solution provided in 3) was used instead of the filtered N-methyl-D-glucamine aqueous solution.

### Example 7

A polishing composition was prepared in the same manner as in Example 1 except that with respect to Example 1, the N-methyl-D-glucamine aqueous solution provided in 3) was used instead of the filtered N-methyl-D-glucamine aqueous solution, and the m-xylene sulfonic acid aqueous solution provided in 4) was used instead of the filtered m-xylene sulfonic acid aqueous solution.

### Comparative Example 1

A polishing composition was prepared in the same manner as in Example 1 except that with respect to Example 1, the maleic acid aqueous solution, the N-methyl-D-glucamine aqueous solution and the m-xylenesulfonic acid aqueous solution provided in 2), 3) and 4), respectively, were not filtered, and the third liquid was not filtered.

### Comparative Example 2

A polishing composition was prepared in the same manner as in Example 1 except that with respect to Example 1, the filtering described in Example 1 was performed only on the mixture X.

### Comparative Example 3

A polishing composition was prepared in the same manner as in Example 1 except that with respect to Example 1, the filtering described in Example 1 was performed only on the third liquid.

### Comparative Example 4

A polishing composition was prepared in the same manner as in Example 1 except that with respect to Example 1, filtering was not performed at all.

### Comparative Example 5

A polishing composition was prepared in the same manner as in Example 1 except that with respect to Example 1, the maleic acid aqueous solution, the N-methyl-D-glucamine aqueous solution and the m-xylenesulfonic acid aqueous solution provided in 2), 3) and 4), respectively, were not filtered, and the mixture X was not filtered.

### Comparative Example 9

A polishing composition was prepared in the same manner as in Example 1 except that with respect to Example 1, the aqueous dispersion of colloidal silica provided in 1) was filtered by pressure filtration at a filtration rate of 500 ml/m for 180 minutes through a 1 inch cartridge filter having a pore size of 3.0 μm (made of polypropylene (depth type)) (manufactured by Roki Techno Co., Ltd.), and except for this, filtering was not performed at all.

### Comparative Example 10

A polishing composition was prepared in the same manner as in Example 1 except that with respect to Example 1, the colloidal silica aqueous dispersion provided in 1) was not filtered, the mixture X was not filtered, and the third liquid was not filtered.

### Provision of Rinse Composition

### Example 4

The hydroxyethyl cellulose-containing liquid provided in 8) was filtered by pressure filtration at a filtration rate of 100 ml/m for 10 minutes through a 1 inch cartridge filter having a pore size of 0.2 μm (ULTIPORE (registered trademark) N66 (pleated type), made of nylon 66, manufactured by Nippon Pole Ltd.), thereby preparing a liquid A.

The iminodiacetic acid and the 2-amino-2-ethyl-1,3-propanediol provided in 6) and 7), respectively, were taken at a mass ratio of 36:64, and mixed with water to prepare an aqueous solution at a total mass concentration of 7% (mixture Z), and the mixture Z was filtered by pressure filtration at a filtration rate of 500 ml/m for 10 minutes through a 1 inch cartridge filter having a pore size of 0.2 μm (ULTIPORE (registered trademark) N66 (pleated type), made of nylon 66, manufactured by Nippon Pole Ltd.), thereby preparing a liquid B.

The liquid A, the liquid B and water were mixed at a mass ratio of 10:100: 890 to prepare a liquid C, and the liquid C was filtered by pressure filtration at a filtration rate of 200 ml/m for 10 minutes through a 1 inch cartridge filter having a pore size of 0.2 μm (ULTIPORE (registered trademark) N66 (pleated type), made of nylon 66, manufactured by Nippon Pole Ltd.), thereby preparing a rinse composition.

### Comparative Example 6

A rinse composition was prepared in the same manner as in Example 4 except that with respect to Example 4, the hydroxyethyl cellulose-containing liquid provided in 8) was not filtered.

### Comparative Example 7

A rinse composition was prepared in the same manner as in Example 4 except that with respect to Example 4, the mixture Z was not filtered.

### Comparative Example 8

A rinse composition was prepared in the same manner as in Example 4 except that with respect to Example 4, the liquid C was not filtered.

### Measurement of Number of Coarse Particles

The number, per unit volume (1 mL), of coarse particles with a size of more than 0.15 μm, which are present in each of the polishing compositions and the rinse compositions obtained in examples and comparative examples, was measured by use of a liquid particle counter (LPC) AccuSizer (registered trademark) FX-nano (manufactured by Nihon Entegris G.K.)). The measurement was performed three times (n=3), and the average value of the three measurements (n=3) was determined, and rounded off to the closest whole number.

### Measurement of Defects

As an object to be polished, a silicon wafer (200 mm, blanket wafer) with a 5,000 Å-thick polysilicon film formed on a surface thereof was provided.

### Evaluation of Polishing Composition

### CMP Step

Polishing treatment was performed under the following conditions by use of the polishing composition prepared in each of Examples 1 to 3 and 5 to 7 and Comparative Examples 1 to 5, 9 and 10.

### -Polishing Apparatus and Polishing Conditions-

Object to be polished: 200 mm polysilicon wafer
Polishing apparatus: one-side polishing apparatus for 200 mm wafer
Polishing pad: foamed polyurethane pad (hardness: 90)
Polishing pressure: 2.3 psi (1 psi =6894.76 Pa, the same applies hereinafter)
Rotation speed of polishing table: 93 rpm
Feeding of polishing composition: non-cyclic flow
Feed rate of polishing composition: 100 mL/min
Rotation speed of head: 87 rpm
Polishing time: 60 seconds

### <<Rinse Polishing Step>>

Subsequently to the CMP step, rinse polishing treatment with GLANZOX 3500 manufactured by Fujimi Inc. was performed on the polysilicon substrate polished in the step.

### -Rinse Polishing Apparatus and Rinse Polishing Conditions-

Rinse polishing apparatus: one-side polishing apparatus for 200 mm wafer
Polishing pad: foamed polyurethane pad (hardness: 90)
Polishing pressure: 1.5 psi
Rotation speed of polishing table: 88 rpm
Feeding of rinse composition: non-cyclic flow
Feed rate of rinse composition: 100 mL/min
Rotation speed of head: 85 rpm
Rinse polishing time: 10 seconds

### Evaluation of Rinse Composition

### CMP Step

Polishing treatment was performed under the following conditions by use of PLANERLITE 6103 manufactured by Fujimi Incorporated.

### -Polishing Apparatus and Polishing Conditions-

Object to be polished: 200 mm polysilicon wafer
Polishing apparatus: one-side polishing apparatus for 200 mm wafer
Polishing pad: foamed polyurethane pad (hardness: 90)
Polishing pressure: 2.3 psi (1 psi =6894.76 Pa, the same applies hereinafter)
Rotation speed of polishing table: 93 rpm
Feeding of polishing composition: non-cyclic flow
Feed rate of polishing composition: 100 mL/min
Rotation speed of head: 87 rpm
Polishing time: 60 seconds

### Rinse Polishing Step

Subsequently to the CMP step, rinse polishing treatment with the rinse composition prepared in each of Examples 4 and Comparative Examples 6 to 8 was performed on the polysilicon substrate polished in the step.

### -Rinse Polishing Apparatus and Rinse Polishing Conditions-

Rinse polishing apparatus: one-side polishing apparatus for 200 mm wafer
Polishing pad: foamed polyurethane pad (hardness: 90)
Polishing pressure: 1.5 psi
Rotation speed of polishing table: 88 rpm
Feeding of rinse composition: non-cyclic flow
Feed rate of rinse composition: 100 mL/min
Rotation speed of head: 85 rpm
Rinse polishing time: 10 seconds

For the surface of the object to be polished, which were obtained by the cleaning described above, defects of 0.1 μm or more on the entire surface of the object to be polished (except for the outer periphery of 5 mm in width) were detected by use of a defect detection apparatus (wafer inspection apparatus) “Surfscan SP2” manufactured by KLA-TENCOR Ltd.

The summary of the above is given in Table 1.

TABLE 1

| | | | | | | Mixture X | | Evaluation item | | |
|---|---|---|---|---|---|---|---|---|---|---|
| | | | | | | (chemical | | | Ability | |
| | | | | | | component- | | | to | Number |
| | | Chemical component | | | | containing | | | achieve | of |
| | | | | m- | Non- | aqueous | | | both | defects |
| | Abrasive | | N- | Xylene | aqueous | solution in | | | quality | (Poly- |
| | grain | Maleic | methyl-D- | sulfonic | additive | the case of | Third | LPC | and pro- | Si 0.1 |
| | dispersion | acid | glucamine | acid | (PEG) | one type) | liquid | >0.15 μm | ductivity | μm UP) |
| Example 1 | ◯ | ◯ | ◯ | ◯ | X | ◯ | ◯ | 426318 | Good | 94 |
| Example 2 | ◯ | ◯ | ◯ | ◯ | ◯ | ◯ | ◯ | 432633 | Slightly | 96 |
| | | | | | | | | | poor | |
| Example 5 | ◯ | ◯ | ◯ | X | X | ◯ | ◯ | 1292032 | Good | 136 |
| Example 6 | ◯ | ◯ | X | ◯ | X | ◯ | ◯ | 1989742 | Good | 129 |
| Example 7 | ◯ | ◯ | X | X | X | ◯ | ◯ | 6321373 | Good | 167 |
| Comparative | ◯ | X | X | X | X | ◯ | X | 61211270 | Poor | 412 |
| Example 1 | | | | | | | | | | |
| Comparative | X | X | X | X | X | ◯ | X | 19482673 | Poor | 312 |
| Example 2 | | | | | | | | | | |
| Comparative | X | X | X | X | X | X | ◯ | 23678229 | Poor | 390 |
| Example 3 | | | | | | | | | | |
| Comparative | X | X | X | X | X | X | X | 462829832 | Poor | 798 |
| Example 4 | | | | | | | | | | |
| Comparative | ◯ | X | X | X | X | X | ◯ | 10784262 | Poor | 289 |
| Example 5 | | | | | | | | | | |
| Comparative | ◯ | X | X | X | X | X | X | 5583672 | Poor | 267 |
| Example 9 | | | | | | | | | | |
| Comparative | X | ◯ | ◯ | ◯ | X | X | X | 128369821 | Poor | 594 |
| Example 10 | | | | | | | | | | |

◯ X indicates the presence or absence of filtering, ◯ indicates that filtering was performed, and X indicates that filtering was not performed.

TABLE 2
Table 1 (continued)

| | | | | | Mixture X | | | | |
|---|---|---|---|---|---|---|---|---|---|
| | | | | | (chemical | | | | |
| | | | | | component- | | Evaluation item | | |
| | | | | | containing | | | Ability to | Number |
| | | | | Non- | aqueous | | | achieve | of defects |
| | Abrasive | Chemical component | | aqueous | solution in | | | both quality | (Poly-Si |
| | grain | Maleic | Iminodiacetic | additive | the case of | Third | LPC | and | 0.1 μm |
| | dispersion | acid | acid | (PEG) | one type) | liquid | >0.15 μm | productivity | UP) |
| Example | ◯ | X | X | X | ◯ | ◯ | 474289 | Good | 96 |
| 3 | | | | | | | | | |

| | Mixture | | | Mixture Z | | | | |
|---|---|---|---|---|---|---|---|---|
| | Y (water- | | | (chemical | | | | |
| | soluble | | | component- | | Evaluation item | | |
| | polymer- | | | containing | | | | Number of |
| | containing | Chemical component | | aqueous | | | Ability to | defects |
| | liquid in | | 2-Amino-2- | solution in | | | achieve both | (Poly-Si |
| | the case of | Iminodiacetic | ethyl-1,3- | the case of | | LPC | quality and | 0.1 |
| | one type) | acid | propanediol | one type) | Liquid C | >0.15 μm | productivity | μm UP) |
| Example 4 | ◯ | X | X | ◯ | ◯ | 582974 | Good | 78 |
| Comparative | X | X | X | ◯ | ◯ | 1257346 | Poor | 189 |
| Example 6 | | | | | | | | |
| Comparative | ◯ | X | X | X | ◯ | 1546879 | Poor | 265 |
| Example 7 | | | | | | | | |
| Comparative | ◯ | X | X | ◯ | X | 1647893 | Poor | 277 |
| Example 8 | | | | | | | | |

◯ X indicates the presence or absence of filtering, ◯ indicates that filtering was performed, and X indicates that filtering was not performed.

In the polishing compositions and the rinse compositions of examples, coarse particles can be reduced, and defects can be suppressed.

The results of Example 2 are interesting. Filtering was performed more in Example 2 than in Example 1, but both the examples were almost equivalent in quality results. That is, in Example 2, it took more time by an amount consumed to perform the filtering operation on the non-aqueous additive, and it was accordingly evaluated that there was a slight decrease in productivity. Thus, for production of the polishing composition, it can be important to select an object to be filtered on the basis of a clear technical idea instead of performing filtering with respect to all components without reason.

The results of Comparative Example 9 are also interesting. The polishing composition of Comparative Example 9 is equivalent in the number of coarse particles to that of Example 7, but defects can be better suppressed in the latter. This suggests that the number of coarse particles and the number of defects do not necessarily correlate, and the process of the present invention produces a different effect which is suppression of defects.

The present application is based on Japanese Patent Application No. 2024-056591 filed on Mar. 29, 2024, the disclosure of which is incorporated herein by reference in its entirety.

What is claimed is:

1. A method for producing a polishing composition, comprising:
preparing a first liquid by providing an abrasive grain dispersion containing abrasive grains and water, and filtering the abrasive grain dispersion;
preparing a second liquid by providing at least one chemical component-containing aqueous solution containing a chemical component and water, and filtering the aqueous solution when one chemical component-containing aqueous solution is provided, or filtering a mixture X containing at least one chemical component-containing aqueous solution; and
mixing the first liquid and the second liquid to prepare a third liquid, and filtering the third liquid.

2. The production method according to claim 1, wherein the abrasive grain contains silica.

3. The production method according to claim 2, wherein the abrasive grain contains colloidal silica.

4. The production method according to claim 1, wherein the chemical component used to prepare at least one chemical component-containing aqueous solution is solid at 25° C.

5. The production method according to claim 1, wherein the mixture X is prepared by providing two or more chemical component-containing aqueous solutions, and filtering at least one of the aqueous solutions, followed by mixing them.

6. The production method according to claim 1, wherein a number of coarse particles having a particle size of more than 0.15 μm is 1,000,000 or less per 1 ml of the polishing composition.

7. The production method according to claim 1, wherein the mixture X is prepared by providing a non-aqueous additive which is liquid at 25° C., and mixing the non-aqueous additive with the chemical component-containing aqueous solution without prior filtration of the non-aqueous additive.

8. A method for producing a rinse composition, comprising:
preparing a liquid A by providing at least one water-soluble polymer-containing liquid containing a water-soluble polymer and water, and filtering the liquid when one water-soluble polymer-containing liquid is provided, or filtering a mixture Y when two or more water-soluble polymer-containing liquids are provided;
preparing a liquid B by providing at least one chemical component-containing aqueous solution containing a chemical component and water, and filtering the aqueous solution when one chemical component-containing aqueous solution is provided, or filtering a mixture Z containing at least one chemical component-containing aqueous solution; and
mixing the liquid A and the liquid B to prepare a liquid C, and filtering the liquid C.

9. The production method according to claim 8, wherein the water-soluble polymer present in at least one of the water-soluble polymer-containing liquids has a radius of inertia of 10 nm or more.

10. The production method according to claim 8, wherein a number of coarse particles having a particle size of more than 0.15 μm is 1,000,000 or less per 1 ml of the rinse composition.

11. The production method according to claim 8, wherein the rinse composition is substantially free of abrasive grains.
